(19) United States
(12) Patent Application Publication
(10) Pub. No.: US 2017/0203753 A1
(43) Pub. Date: Jul. 20, 2017

(54) HYBRID WORK MACHINE ENGINE CONTROL DEVICE, HYBRID WORK MACHINE, HYBRID WORK MACHINE ENGINE CONTROL METHOD

(71) Applicant: Komatsu Ltd., Tokyo (JP)

(72) Inventors: Tomotaka Imai, Hiratsuka-shi (JP); Tsubasa Ohira, Hiratsuka-shi (JP); Masaru Shizume, Yokohama-shi (JP); Tadashi Kawaguchi, Hiratsuka-shi (JP)

(21) Appl. No.: 15/117,342

(22) PCT Filed: Jan. 20, 2016
(86) PCT No.: PCT/JP2016/051628

§ 371 Date: Aug. 8, 2016

(51) Int. Cl. B60W 20/15; B60W 10/08; B60W 10/06; B60W 10/30

(52) U.S. Cl. CPC B60W 20/15; B60W 10/30; B60W 10/08; B60W 10/06; B60W 2300/17; B60W 2510/085; B60W 2710/0666; Y10S 903/93

(57) ABSTRACT

A hybrid work machine engine control device which is mounted on a hybrid work machine having a working unit that operates with operating oil supplied from a hydraulic pump and which controls an internal combustion engine that drives a generator motor and the hydraulic pump with generated power, includes: a processing unit that increases torque required for the generator motor to generate electric power with a lapse of time and decreases absorption torque that the hydraulic pump absorbs when the generator motor generates electric power during operation of the internal combustion engine.

### FIELD

The present invention relates to a technique for controlling an engine provided in a hybrid work machine as a power source.

### BACKGROUND

A work machine includes an internal combustion engine, for example, as a power source for generating traveling power or power for operating a working unit. In recent years, as disclosed in Patent Literature 1, for example, a work machine in which an internal combustion engine and a generator motor are combined so that power generated by the internal combustion engine is used as the power for a work machine, and the generator motor is driven by the internal combustion engine to generate electric power has been developed.

### CITATION LIST

### Patent Literatures

Patent Literature 1: Japanese Patent Application Laid-open No. 2012-241585

### SUMMARY

### Technical Problem

In a hybrid work machine including an internal combustion engine and a generator motor driven by the internal combustion engine, when the generator motor is driven by the internal combustion engine to generate electric power, the rotation speed of the internal combustion engine may increase after a short period of decrease. During power generation, such a variation in the rotation speed that the rotation speed of the internal combustion engine increases after a short period of decrease may not be allowable.

An object of an aspect of the present invention is to provide a hybrid work machine including a generator motor driven by an internal combustion engine, in which a variation in the rotation speed of the internal combustion engine is suppressed when the generator motor generates electric power.

### Solution to Problem

According to a first aspect of the present invention, a hybrid work machine engine control device which is mounted on a hybrid work machine having a working unit that operates with operating oil supplied from a hydraulic pump and which controls an internal combustion engine that drives a generator motor and the hydraulic pump with generated power, comprises: a processing unit that increases torque required for the generator motor to generate electric power with a lapse of time and decreases absorption torque that the hydraulic pump absorbs when the generator motor generates electric power during operation of the internal combustion engine.

According to a second aspect of the present invention, in the hybrid work machine engine control device according to the first aspect, the processing unit changes a rate at which the torque required for the generator motor to generate electric power is increased with the lapse of time based on an amount of electric power stored in a storage battery device that stores the electric power generated by the generator motor.

According to a third aspect of the present invention, in the hybrid work machine engine control device according to the second aspect, the processing unit increases the rate as the amount of electric power decreases.

According to a fourth aspect of the present invention, in the hybrid work machine engine control device according to any one of aspects 1 to 3, it is determined whether the generator motor generates electric power based on an amount of electric power stored in a storage battery device that stores the electric power generated by the generator motor.

According to a fifth aspect of the present invention, in the hybrid work machine engine control device according to any one of aspects 1 to 4, the hybrid work machine includes a swing structure having the working unit, and the processing unit changes a rate at which the torque required for the generator motor to generate electric power is increased with the lapse of time based on swing horsepower required for the swing structure to swing.

According to a sixth aspect of the present invention, in the hybrid work machine engine control device according to the fifth aspect, the processing unit increases the rate as the swing horsepower increases.

According to a seventh aspect of the present invention, a hybrid work machine comprises: the hybrid work machine engine control device according to any one of aspects 1 to 6; the internal combustion engine; a hydraulic pump driven by the internal combustion engine; the generator motor driven by the internal combustion engine; and a storage battery device that stores electric power generated by the generator motor.

According to a eighth aspect of the present invention, an engine control method for controlling a hybrid work machine, the engine control method controlling an internal combustion engine which is mounted on the hybrid work machine having a working unit operated by a hydraulic pump and which drives a generator motor and the hydraulic pump with generated power, the engine control method comprises: determining whether the generator motor generates electric power or not during operation of the internal combustion engine; and increasing torque required for the generator motor to generate electric power with a lapse of time and decreasing absorption torque that the hydraulic pump absorbs when the generator motor generates electric power during operation of the internal combustion engine.

According to the aspects of the present invention, it is possible to provide a hybrid work machine including a generator motor driven by an internal combustion engine, in which a variation in the rotation speed of the internal combustion engine is suppressed when the generator motor generates electric power.

### BRIEF DESCRIPTION OF DRAWINGS

FIG. 1 is a perspective view illustrating an excavator which is a work machine according to an embodiment.

FIG. 2 is a schematic diagram illustrating a driving system of the excavator according to an embodiment.

FIG. 3 is a diagram illustrating an example of a torque diagram used for controlling an engine according to an embodiment.

FIG. 4 is a diagram for describing an operating state of an internal combustion engine when a generator motor is driven by an internal combustion engine to generate electric power.

FIG. 5 is a diagram illustrating an example of a change with time in power generation torque when a generator motor generates electric power in an embodiment.

FIG. 6 is a diagram for describing an operating state of an internal combustion engine when a generator motor is driven by the internal combustion engine to generate electric power.

FIG. 7 is a diagram for describing an operating state of an internal combustion engine when a generator motor is driven by the internal combustion engine to generate electric power.

FIG. 8 is a diagram for describing an operating state of an internal combustion engine when a generator motor is driven by the internal combustion engine to generate electric power according to a comparative example.

FIG. 9 is a timing chart for describing an operating state of an internal combustion engine when a generator motor is driven by the internal combustion engine to generate electric power according to a comparative example.

FIG. 10 is a diagram illustrating a configuration example of a hybrid controller, an engine controller, and a pump controller.

FIG. 11 is a diagram illustrating a control system of an excavator.

FIG. 12 is a control block diagram of a hybrid controller that executes a hybrid work machine engine control method according to an embodiment.

FIG. 13 is a control block diagram of a hybrid controller that executes a hybrid work machine engine control method according to an embodiment.

FIG. 14 is a control block diagram of a hybrid controller that executes a hybrid work machine engine control method according to an embodiment.

FIG. 15 is a flowchart illustrating a process of an input value calculation unit.

FIG. 16 is a control block diagram of a hybrid controller that executes a hybrid work machine engine control method according to an embodiment.

FIG. 17 is a flowchart illustrating an example of a hybrid work machine engine control method according to an embodiment.

FIG. 18 is a diagram for describing a modified example of an output command line according to an embodiment.

### DESCRIPTION OF EMBODIMENTS

Modes (embodiments) for carrying out the present invention will be described in detail with reference to the drawings.

<Overall Structure of Construction Machine>

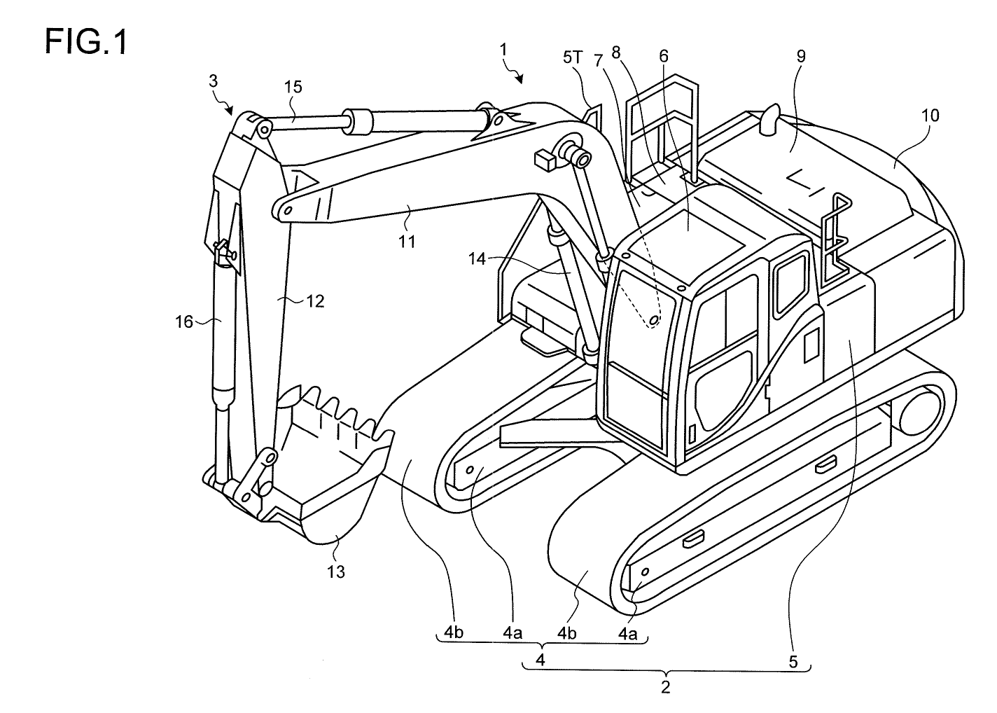

FIG. 1 is a perspective view illustrating an excavator 1 which is a work machine according to an embodiment. The excavator 1 includes a vehicle body 2 and a working unit 3. The vehicle body 2 includes a lower traveling structure 4 and an upper swing structure 5. The lower traveling structure 4 includes a pair of traveling devices 4a, 4a. The traveling devices 4a, 4a include crawlers 4b. The traveling devices 4a, 4a each include a traveling motor 21. The traveling motor 21 illustrated in FIG. 1 drives the left-side crawler 4b. Although not illustrated in FIG. 1, the excavator 1 also includes a traveling motor that drives the right-side crawler 4b. The traveling motor that drives the left-side crawler 4b is referred to as a left-side traveling motor and the traveling motor that drives the right-side crawler 4b is referred to as a right-side traveling motor. The right-side traveling motor and the left-side traveling motor drive the crawlers 4b, 4b to allow the excavator 1 to travel or swing.

The upper swing structure 5 which is an example of a swing structure is provided on the lower traveling structure 4 so as to be able to swing. The excavator 1 swings with the aid of a swing motor for allowing the upper swing structure 5 to swing. The swing motor may be an electric motor that converts electric power to rotating force, may be a hydraulic motor that converts pressure (hydraulic pressure) of operating oil to rotating force, and may be a combination of a hydraulic motor and an electric motor. In the embodiment, the swing motor is an electric motor.

The upper swing structure 5 includes a cab 6. Further, the upper swing structure 5 includes a fuel tank 7, an operating oil tank 8, an engine room 9, and a counterweight 10. The fuel tank 7 stores fuel for driving an engine. The operating oil tank 8 stores operating oil discharged from a hydraulic pump to a hydraulic cylinder such as a boom cylinder 14, an arm cylinder 15, and a bucket cylinder 16, and a hydraulic device such as the traveling motor 21. The engine room 9 accommodates devices such as an engine serving as a power source of the excavator and a hydraulic pump that supplies operating oil to the hydraulic device. The counterweight 10 is disposed on the rear side of the engine room 9. A handrail 5T is attached to an upper portion of the upper swing structure 5.

The working unit 3 is attached to a central position of a front portion of the upper swing structure 5. The working unit 3 includes a boom 11, an arm 12, a bucket 13, the boom cylinder 14, the arm cylinder 15, and the bucket cylinder 16. A base end of the boom 11 is coupled to the upper swing structure 5 by a pin. With such a structure, the boom 11 operates in relation to the upper swing structure 5.

The boom 11 is coupled to the arm 12 by a pin. More specifically, a distal end of the boom 11 is coupled to the base end of the arm 12 by a pin. The distal end of the arm 12 is coupled to the bucket 13 by a pin. With such a structure, the arm 12 operates in relation to the boom 11. Moreover, the bucket 13 operates in relation to the arm 12.

The boom cylinder 14, the arm cylinder 15, and the bucket cylinder 16 are hydraulic cylinders that are driven with the operating oil discharged from a hydraulic pump 18. The boom cylinder 14 operates the boom 11. The arm cylinder 15 operates the arm 12. The bucket cylinder 16 operates the bucket 13. In this way, the working unit 3 operates with the operating oil supplied from the hydraulic pump 18 with the aid of the boom cylinder 14, the arm cylinder 15, and the bucket cylinder 16.

<Driving System 1PS of Excavator 1>

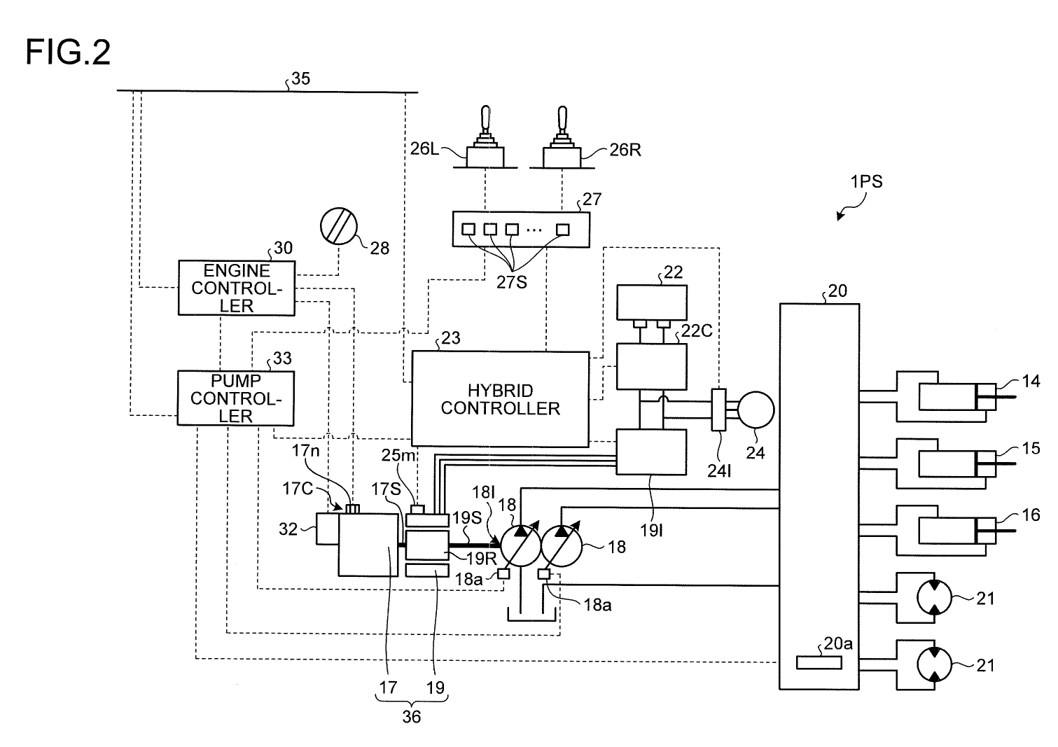

FIG. 2 is a schematic diagram illustrating a driving system of the excavator 1 according to the embodiment. In the embodiment, the excavator 1 is a hybrid work machine in which an internal combustion engine 17, a generator motor 19 that is driven by the internal combustion engine 17 to generate electric power, a storage battery device 22 that stores electric power, and a motor that is driven by being supplied with the electric power generated by the generator motor 19 or the electric power discharged from the storage battery device 22 are combined. More specifically, the excavator 1 allows the upper swing structure 5 to swing with the aid of a motor 24 (hereinafter appropriately referred to as a swing motor 24).

The excavator 1 includes the internal combustion engine 17, the hydraulic pump 18, the generator motor 19, and the swing motor 24. The internal combustion engine 17 is a power source of the excavator 1. In the embodiment, the internal combustion engine 17 is a diesel engine. The generator motor 19 is connected to an output shaft 17S of the internal combustion engine 17. With such a structure, the generator motor 19 is driven by the internal combustion engine 17 to generate electric power. Moreover, the generator motor 19 is driven with the electric power supplied from the storage battery device 22 to assist the internal combustion engine 17 when the power generated by the internal combustion engine 17 is insufficient.

In the embodiment, although the internal combustion engine 17 is a diesel engine, the internal combustion engine 17 is not limited thereto. Although the generator motor 19 is a switched reluctance (SR) motor, for example, the generator motor 19 is not limited thereto. In the embodiment, although the generator motor 19 has a structure in which a rotor 19R is directly connected to the output shaft 17S of the internal combustion engine 17, the generator motor 19 is not limited to such a structure. For example, the generator motor 19 may have a structure in which the rotor 19R and the output shaft 17S of the internal combustion engine 17 are connected by a power take-off (PTO). The rotor 19R of the generator motor 19 may be connected to transmission means such as a reduction gear connected to the output shaft 17S of the internal combustion engine 17 and be driven by the internal combustion engine 17. In the embodiment, a combination of the internal combustion engine 17 and the generator motor 19 forms a power source of the excavator 1. The combination of the internal combustion engine 17 and the generator motor 19 will be appropriately referred to as an engine 36. The engine 36 is a hybrid engine in which the internal combustion engine 17 and the generator motor 19 are combined to generate power required for the excavator 1.

The hydraulic pump 18 supplies operating oil to the hydraulic device to operate the working unit 3, for example. In the present embodiment, a variable displacement hydraulic pump such as a swash plate hydraulic pump, for example, is used as the hydraulic pump 18. An input portion 181 of the hydraulic pump 18 is connected to a power transmission shaft 19S connected to the rotor 19R of the generator motor 19. With such a structure, the hydraulic pump 18 is driven by the internal combustion engine 17.

The driving system 1PS includes the storage battery device 22 and a swing motor control device 24I as an electric driving system for driving the swing motor 24. In the embodiment, although the storage battery device 22 is a capacitor (more specifically, an electric double-layer capacitor), the storage battery device 22 is not limited thereto but may be a secondary battery such as a nickel-metal hydride battery, a lithium ion battery, or a lead-acid battery. The swing motor control device 24I is an inverter, for example.

The electric power generated by the generator motor 19 or the electric power discharged from the storage battery device 22 is supplied to the swing motor 24 via a power cable to allow the upper swing structure 5 illustrated in FIG. 1 to swing. That is, the swing motor 24 performs a powering operation with the electric power supplied (generated) from the generator motor 19 or the electric power supplied (discharged) from the storage battery device 22 to allow the upper swing structure 5 to swing. The swing motor 24 supplies (charges) the storage battery device 22 with electric power by performing a regenerative operation when the upper swing structure 5 decelerates. Moreover, the generator motor 19 supplies (charges) the storage battery device 22 with the electric power generated by itself. That is, the storage battery device 22 can store the electric power generated by the generator motor 19.

The generator motor 19 generates electric power by being driven by the internal combustion engine 17 and drives the internal combustion engine 17 by being driven with the electric power supplied from the storage battery device 22. A hybrid controller 23 controls the generator motor 19 with the aid of a generator motor control device 19I. That is, the hybrid controller 23 generates a control signal for driving the generator motor 19 and supplies the control signal to the generator motor control device 19I. The generator motor control device 19I allows the generator motor 19 to generate (regenerate) electric power based on the control signal and allows the generator motor 19 to generate power (to perform a powering operation). The generator motor control device 19I is an inverter, for example.

A rotation sensor 25m is provided in the generator motor 19. The rotation sensor 25m detects a rotation speed of the generator motor 19 (that is, an engine speed per unit time of the rotor 19R). The rotation sensor 25m converts the detected rotation speed to an electrical signal and outputs the electrical signal to the hybrid controller 23. The hybrid controller 23 acquires the rotation speed of the generator motor 19, detected by the rotation sensor 25m and uses the rotation speed in controlling the operating state of the internal combustion engine 17 and the generator motor 19. A resolver, a rotary encoder, or the like, for example, is used as the rotation sensor 25m. In the embodiment, the rotation speed of the generator motor 19 and the rotation speed of the internal combustion engine 17 are the same rotation speed. In the embodiment, the rotation sensor 25m may be configured to detect an engine speed of the rotor 19R of the generator motor 19 and the hybrid controller 23 may be configured to convert the engine speed to a rotation speed. A value detected by a rotation speed detection sensor 17n of the internal combustion engine 17 may be used as the rotation speed of the generator motor 19.

The rotation sensor 25m is provided in the swing motor 24. The rotation sensor 25m detects the rotation speed of the swing motor 24. The rotation sensor 25m converts the detected rotation speed to an electrical signal and outputs the electrical signal to the hybrid controller 23. An embedded magnet synchronous motor, for example, is used as the swing motor 24. A resolver, a rotary encoder, or the like, for example, is used as the rotation sensor 25m.

The hybrid controller 23 acquires a detection value signal obtained by a temperature sensor such as a thermistor or a thermocouple, provided in the generator motor 19, the swing motor 24, the storage battery device 22, the swing motor control device 24I, and the generator motor control device 19I (described later). The hybrid controller 23 manages the temperatures of respective devices such as the storage battery device 22 based on the acquired temperature and executes control of charge/discharge of the storage battery device 22, control of power generation of the generator motor 19, assist control of the internal combustion engine 17, and powering/regeneration control of the swing motor 24. Moreover, the hybrid controller 23 executes the engine control method according to the embodiment.

The storage battery device 22 is connected to a transformer 22C. The transformer 22C is connected to the generator motor control device 19I and the swing motor control device 24I. The transformer 22C transmits and receives DC electric power to and from the generator motor control device 19I and the swing motor control device 24I. The hybrid controller 23 allows the transformer 22C to transmit and receive DC electric power to and from the generator motor control device 19I and the swing motor control device 24I and allows the transformer 22C to transmit and receive DC electric power to and from the storage battery device 22.

The driving system 1PS includes operating levers 26R, 26L provided on the left and right positions in relation to an operator's sitting position in the cab 6 provided in the vehicle body 2 illustrated in FIG. 1. The operating levers 26R, 26L are devices that operate the working unit 3 and operate the travel of the excavator 1. The operating levers 26R, 26L operate the working unit 3 and the upper swing structure 5 according to respective operations.

Pilot pressure is generated based on an operation amount of the operating levers 26R, 26L. The pilot pressure is supplied to a control valve described later. The control valve drives a spool of the working unit 3 according to the pilot pressure. With movement of the spool, the operating oil is supplied to the boom cylinder 14, the arm cylinder 15, and the bucket cylinder 16. As a result, for example, the boom 11 is lowered and raised according to an operation in the front-rear direction of the operating lever 26R, and the bucket 13 performs an excavation/dumping operation according to an operation in the left-right direction of the operating lever 26R. Moreover, for example, the arm 12 performs a dumping/excavation operation according to an operation in the front-rear direction of the operating lever 26L. Moreover, the operation amount of the operating levers 26R, 26L is converted to an electrical signal by a lever operation amount detection unit 27. The lever operation amount detection unit 27 includes a presence sensor 27S. The presence sensor 27S detects a pilot pressure generated according to an operation of the operating levers 26L, 26R. The presence sensor 27S outputs a voltage corresponding to the detected pilot pressure. The lever operation amount detection unit 27 calculates a lever operation amount by converting the voltage output by the presence sensor 27S to an operation amount.

The lever operation amount detection unit 27 outputs the lever operation amount to at least one of a pump controller 33 and the hybrid controller 23 as an electrical signal. When the operating levers 26L, 26R are electric levers, the lever operation amount detection unit 27 includes an electric detection device such as a potentiometer. The lever operation amount detection unit 27 converts the voltage generated by the electric detection device according to the lever operation amount to calculate the lever operation amount. As a result, for example, the swing motor 24 is driven in a left-right swing direction according to the operation in the left-right direction of the operating lever 26L. Moreover, the traveling motor 21 is driven by left and right travel levers (not illustrated).

A fuel adjustment dial 28 is provided in the cab 6 illustrated in FIG. 1. In the following description, the fuel adjustment dial 28 is appropriately referred to a throttle dial 28. The throttle dial 28 sets the amount of fuel supplied to the internal combustion engine 17. The setting value (also referred to as a command value) of the throttle dial 28 is converted to an electrical signal and is output to an internal combustion engine control device (hereinafter appropriately referred to as an engine controller) 30.

The engine controller 30 acquires the rotation speed of the internal combustion engine 17 and a sensor output value such as a water temperature from sensors 17C that detect the state of the internal combustion engine 17. Moreover, the engine controller 30 detects the state of the internal combustion engine 17 from the acquired output values of the sensors 17C and adjusts the amount of fuel injected to the internal combustion engine 17 to thereby control the output of the internal combustion engine 17. In the embodiment, the engine controller 30 includes a computer having a processor such as a central processing unit (CPU) and a memory.

The engine controller 30 generates a control command signal for controlling the operation of the internal combustion engine 17 based on the setting value of the throttle dial 28. The engine controller 30 transmits the generated control signal to a common rail control unit 32. The common rail control unit 32 having received the control signal adjusts the amount of fuel injected to the internal combustion engine 17. That is, in the embodiment, the internal combustion engine 17 is a diesel engine capable of performing common rail-based electronic control. The engine controller 30 can allow the internal combustion engine 17 to generate target output by controlling the amount of fuel injected to the internal combustion engine 17 with the aid of the common rail control unit 32. Moreover, the engine controller 30 can freely set the torque that can be output at the rotation speed of the internal combustion engine 17 at a certain moment. The hybrid controller 23 and the pump controller 33 receive the setting value of the throttle dial 28 from the engine controller 30.

The internal combustion engine 17 includes the rotation speed detection sensor 17n. The rotation speed detection sensor 17n detects the rotation speed of the output shaft 17S of the internal combustion engine 17 (that is, the engine speed per unit time of the output shaft 17S). The engine controller 30 and the pump controller 33 acquire the rotation speed of the internal combustion engine 17, detected by the rotation speed detection sensor 17n and use the rotation speed in controlling the operating state of the internal combustion engine 17. In the embodiment, the rotation speed detection sensor 17n may be configured to detect the engine speed of the internal combustion engine 17, and the engine controller 30 and the pump controller 33 may be configured to convert the engine speed to a rotation speed. In the embodiment, the value detected by the rotation sensor 25m of the generator motor 19 can be used as the actual rotation speed of the internal combustion engine 17.

The pump controller 33 controls the flow rate of the operating oil discharged from the hydraulic pump 18. In the embodiment, the pump controller 33 includes a computer having a processor such as a CPU and a memory. The pump controller 33 receives signals transmitted from the engine controller 30 and the lever operation amount detection unit 27. Moreover, the pump controller 33 generates a control command signal for adjusting the flow rate of the operating oil discharged from the hydraulic pump 18. The pump controller 33 changes the flow rate of the operating oil discharged from the hydraulic pump 18 by changing a swash plate angle of the hydraulic pump 18 using the generated control signal.

A signal from a swash plate angle sensor 18a that detects a swash plate inclination angle of the hydraulic pump 18 is input to the pump controller 33. When the swash plate angle sensor 18a detects a swash plate angle, the pump controller 33 can calculate a pump capacity of the hydraulic pump 18. A pump pressure detection unit 20a for detecting a discharge pressure (hereinafter appropriately referred to as a pump discharge pressure) of the hydraulic pump 18 is provided in a control valve 20. The detected pump discharge pressure is converted to an electrical signal and is input to the pump controller 33.

The engine controller 30, the pump controller 33, and the hybrid controller 23 are connected to an in-vehicle local area network (LAN) 35 such as a controller area network (CAN), for example. With such a structure, the engine controller 30, the pump controller 33, and the hybrid controller 23 can exchange information with each other.

In the embodiment, at least the engine controller 30 controls the operating state of the internal combustion engine 17. In this case, the engine controller 30 controls the operating state of the internal combustion engine 17 using information generated by at least one of the pump controller 33 and the hybrid controller 23. In this manner, in the embodiment, at least one of the engine controller 30, the pump controller 33, and the hybrid controller 23 functions as a hybrid work machine engine control device (hereinafter appropriately referred to as an engine control device). That is, at least one of the controllers realizes a hybrid work machine engine control method (hereinafter appropriately referred to as an engine control method) to control the operating state of the engine 36. In the following description, when the engine controller 30, the pump controller 33, and the hybrid controller 23 are not distinguished, these controllers are sometimes referred to as an engine control device. In the embodiment, the hybrid controller 23 realizes the function of the engine control device.

<Control of Engine 36>

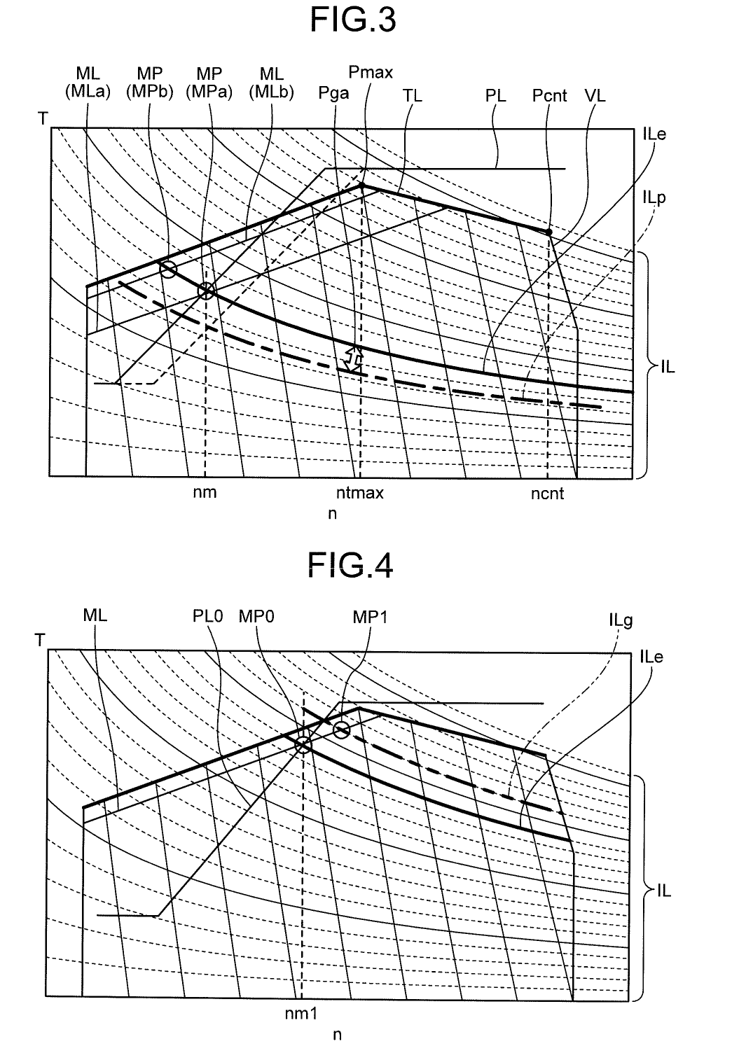

FIG. 3 is a diagram illustrating an example of a torque diagram used for controlling the engine 36 according to the embodiment. The torque diagram is used for controlling the engine 36 (more specifically, the internal combustion engine 17). The torque diagram illustrates the relation between the torque T (N·m) of the output shaft 17S of the internal combustion engine 17 and the rotation speed n (rpm: rev/min) of the output shaft 17S. In the embodiment, since the rotor 19R of the generator motor 19 is connected to the output shaft 17S of the internal combustion engine 17, the rotation speed n of the output shaft 17S of the internal combustion engine 17 is the same as the rotation speed of the rotor 19R of the generator motor 19. In the following description, the rotation speed n means at least one of the rotation speed of the output shaft 17S of the internal combustion engine 17 and the rotation speed of the rotor 19R of the generator motor 19. In the embodiment, the output of the internal combustion engine 17 (the output when the generator motor 19 operates as a motor) is horsepower and the unit is power.

The torque diagram includes a maximum torque line TL, a limit line VL, a pump absorption torque line PL, a matching line ML, and an output command line IL. The maximum torque line TL indicates a maximum output that the internal combustion engine 17 can generate during operation of the excavator 1 illustrated in FIG. 1. The maximum torque line TL indicates the relation between the rotation speed n of the internal combustion engine 17 and the torque T that the internal combustion engine 17 can generate at each rotation speed n.

The torque diagram is used for controlling the internal combustion engine 17. In the embodiment, the engine controller 30 stores the torque diagram in a memory unit and uses the torque diagram in controlling the internal combustion engine 17. At least one of the hybrid controller 23 and the pump controller 33 may store the torque diagram in a memory unit.

The torque T of the internal combustion engine 17 indicated by the maximum torque line TL is determined by taking the durability, the exhaust smoke limitation, and the like of the internal combustion engine 17 into consideration. Thus, the internal combustion engine 17 can generate torque larger than the torque T corresponding to the maximum torque line TL. Practically, the engine control device (for example, the engine controller 30) controls the internal combustion engine 17 so that the torque T of the internal combustion engine 17 does not exceed the maximum torque line TL.

The output (that is, the horsepower) generated by the internal combustion engine 17 becomes largest at an intersection Pcnt between the limit line VL and the maximum torque line TL. The intersection Pcnt is referred to as a rated point. The output of the internal combustion engine 17 at the rated point Pcnt is referred to as a rated output. The maximum torque line TL is determined based on the exhaust smoke limitation as described above. The limit line VL is determined based on a highest rotation speed. Thus, the rated output is the maximum output of the internal combustion engine 17, determined based on the exhaust smoke limitation and the highest rotation speed of the internal combustion engine 17.

The limit line VL limits the rotation speed n of the internal combustion engine 17. That is, the rotation speed n of the internal combustion engine 17 is controlled by the engine control device (for example, the engine controller 30) so as not to exceed the limit line VL. The limit line VL defines the maximum rotation speed of the internal combustion engine 17. That is, the engine control device (for example, the engine controller 30) controls the internal combustion engine 17 so that the maximum rotation speed of the internal combustion engine 17 does not exceed the rotation speed defined by the limit line VL.

The pump absorption torque line PL indicates maximum torque that the hydraulic pump 18 illustrated in FIG. 2 can absorb in relation to the rotation speed n of the internal combustion engine 17. In the embodiment, the internal combustion engine 17 balances the output of the internal combustion engine 17 with the load of the hydraulic pump 18 on the matching line ML. FIG. 3 illustrates a matching line MLa and a matching line MLb. The matching line MLb is closer to the maximum torque line TL than the matching line MLa.

The matching line MLb is set so that, when the internal combustion engine 17 operates with a predetermined output (for example, at the same output), the rotation speed n is lower than the matching line MLa. By doing so, when the internal combustion engine 17 generates the same torque T, since the matching line MLb allows the internal combustion engine 17 to operate at a lower rotation speed n, it is possible to reduce the loss caused by internal friction of the internal combustion engine 17.

According to the matching line ML, the torque T increases when the rotation speed n of the internal combustion engine 17 increases. The matching line ML and the limit line TL cross each other in an area between a rotation speed ntmax corresponding to a maximum torque point Pmax defined by the limit line TL and a rotation speed ncnt corresponding to the rated output point Pcnt. At the maximum torque point Pmax, the torque T generated by the internal combustion engine 1 becomes largest.

The matching line ML may be set so as to pass through a point at which a satisfactory fuel consumption rate is obtained. The matching line MLb is set to be between 80% and 95% of the torque T determined by the maximum torque line TL in a range in which the internal combustion engine 17 generates the maximum torque T.

The output command line IL indicates the targets of the rotation speed n and the torque T of the internal combustion engine 17. That is, the internal combustion engine 17 is controlled so as to operate at the rotation speed n and the torque T obtained from the output command line IL. In this manner, the output command line IL corresponds to a second relation indicating the relation between the torque T and the rotation speed n of the internal combustion engine 17, used for defining the magnitude of power generated by the internal combustion engine 17. The output command line IL corresponds to a command value (hereinafter appropriately referred to as an output command value) of the horsepower (that is, the output) that the internal combustion engine 17 is to generate. That is, the engine control device (for example, the engine controller 30) controls the torque T and the rotation speed n of the internal combustion engine 17 so as to be the torque T and the rotation speed n on the output command line IL corresponding to the output command value. For example, when an output command line ILt corresponds to the output command value, the torque T and the rotation speed n of the internal combustion engine 17 are controlled so as to be the values on the output command line ILt.

The torque diagram includes a plurality of output command lines IL. A value between adjacent output command lines IL is obtained by interpolation, for example. In the embodiment, the output command line IL is an equivalent horsepower line. The equivalent horsepower line determines the relation between the torque T and the rotation speed n so that the output of the internal combustion engine 17 becomes constant. In the embodiment, the output command line IL is not limited to the equivalent horsepower line but may be an equivalent throttle line. The equivalent throttle line indicates the relation between the torque T and the rotation speed n when the setting value (a throttle opening) of the fuel adjustment dial (that is, the throttle dial 28) is the same. The setting value of the throttle dial 28 is a command value for determining the amount of the fuel that the common rail control unit 32 injects to the internal combustion engine 17. An example in which the output command line IL is an equivalent throttle line will be described later.

In the embodiment, the internal combustion engine 17 is controlled so as to operate at the torque T and the rotation speed nm corresponding to a matching point MP. The matching point MP is an intersection of the matching line ML indicated by a solid line in FIG. 3, an output command line ILe indicated by the solid line in FIG. 3, and a pump absorption torque line PL indicated by the solid line. The matching point MP is a point at which the output of the internal combustion engine 17 balances with the load of the hydraulic pump 18. The output command line ILe indicated by the solid line corresponds to the target of the output of the internal combustion engine 17 that the hydraulic pump 18 absorbs at the matching point MP and the target output of the internal combustion engine 17.

When the generator motor 19 generates electric power, a command is output to the pump controller 33 and the hybrid controller 23 so that the output of the internal combustion engine 17 absorbed by the hydraulic pump 18 decreases by the horsepower (that is, an output Pga) absorbed by the generator motor 19. The pump absorption torque line PL moves to a position indicated by a dot line. An output command line ILp corresponds to a pump absorption horsepower at this moment. The pump absorption torque line PL crosses the output command line ILp at the rotation speed nm corresponding to a matching point MPa. The output command line ILe that passes through the matching point MPa is an addition of the output command line ILp and the output Pga absorbed by the generator motor 19.

The embodiment illustrates an example in which the output of the internal combustion engine 17 balances with the load of the hydraulic pump 18 at the matching point MPa which is an intersection of the matching line MLa, the output command line ILe, and the pump absorption torque line PL. However, the embodiment is not limited to this example, but the output of the internal combustion engine 17 may balance with the load of the hydraulic pump 18 at a matching point MPb that is an intersection of the matching line MLb, the output command line ILe, and the pump absorption torque line PL.

In this manner, the engine 36 (that is, the internal combustion engine 17 and the generator motor 19) is controlled based on the maximum torque line TL, the limit line VL, the pump absorption torque line PL, the matching line ML, and the output command line IL included in the torque diagram. Next, a case where the generator motor 19 of the engine 36 is driven by the internal combustion engine 17 and the generator motor 19 generates electric power will be described.

<Case Where Generator Motor 19 Generates Electric Power>

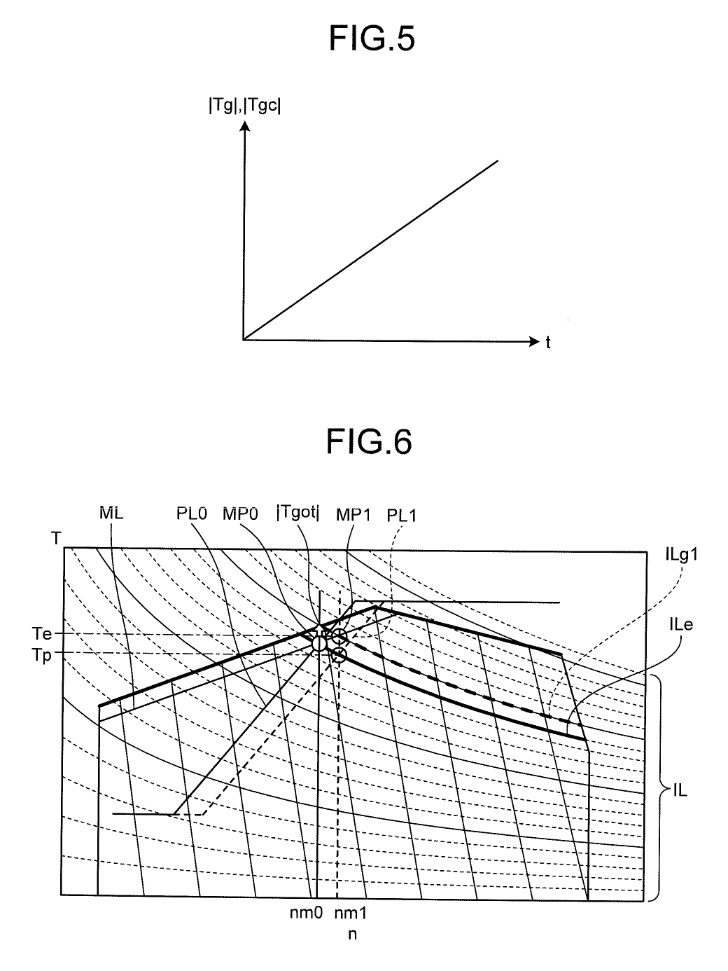

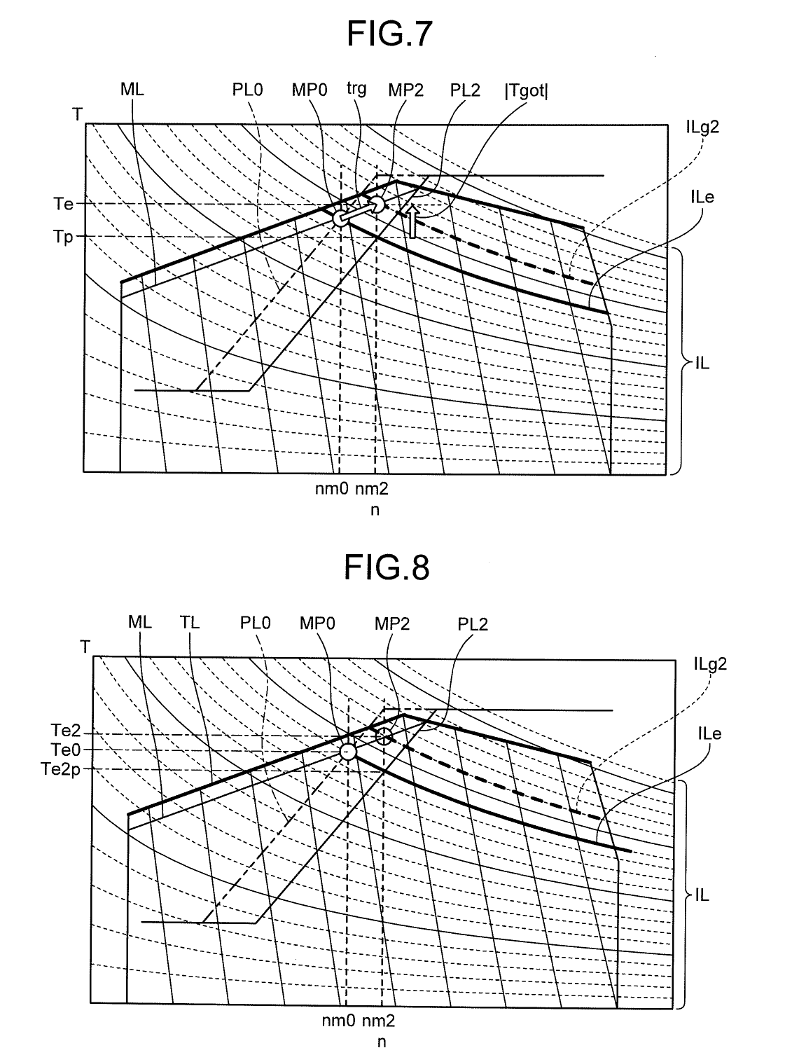

FIG. 4 is a diagram for describing an operating state of the internal combustion engine 17 when the generator motor 19 is driven by the internal combustion engine 17 to generate electric power and the generated output is Pga or larger. The output command line ILe in FIG. 4 is an output command line when the internal combustion engine 17 is operated solely. The output command line ILg in FIG. 4 is an output command line indicating a target output when the generator motor 19 is driven by the internal combustion engine 17 to generate electric power. The same output command line ILe and the same output command line ILg are applied to FIGS. 6 and 7 described later.

In FIG. 4, the output command line ILe indicates an output command value output to the internal combustion engine 17 when the generator motor 19 is not generating power. The output command line ILg indicates an output command value output to the internal combustion engine 17 when the generator motor 19 is generating power. Since energy for power generation is required when the generator motor 19 is generating power, the output command line ILg for power generation is larger than the output command line ILe for non-power generation. That is, the internal combustion engine 17 generates a larger output during power generation time than during non-power generation time.

In FIG. 4, the output of the internal combustion engine 17 when the generator motor 19 is not generating power balances with the load of the hydraulic pump 18 at a matching point MP0 which is an intersection of the matching line ML, the output command line ILe, and the pump absorption torque line PL0. At the matching point MP0, the rotation speed of the internal combustion engine 17 is nm1.

When a power generation command is output from the hybrid controller 23 illustrated in FIG. 2 to the generator motor 19 and the generator motor 19 starts power generation, the internal combustion engine 17 generates power for driving the generator motor 19. Since the output command value output to the internal combustion engine 17 during power generation is the output command line ILg, the matching point is MP1, for example. The rotation speed at the matching point MP1 is larger than the rotation speed nm at the matching point MP1. When the generator motor 19 stops power generation, the internal combustion engine 17 does not need to drive the generator motor 19. Thus, since the output command value output to the internal combustion engine 17 during stopped power generation is the output command line ILe from the output command line ILg, the matching point returns to MP0. The rotation speed nm1 at the matching point MP0 is smaller than the rotation speed at the matching point MP1.

When the output of the internal combustion engine 17 increases abruptly with power generation of the generator motor 19, the rotation speed n of the internal combustion engine 17 increases abruptly. As a result, the operator of the excavator 1 may feel a sense of incongruity. For example, during chipping or excavation which is an operation that does not involve the operation of the upper swing structure 5 of the excavator 1, when the voltage of the storage battery device 22 decreases up to a voltage at which power generation starts due to natural discharge, the generator motor 19 starts power generation. In this case, although the operation of the operator on the operating levers 26L, 26R of the excavator 1 does not change, the operator may feel a sense of incongruity since the rotation speed n of the internal combustion engine 17 changes, the pump flow rate changes due to a change in the rotation speed n of the internal combustion engine 17 so that an operational feeling which leads to a feeling that the working unit 3 springs out changes, and the sound generated by the internal combustion engine 17 changes.

In the embodiment, when the generator motor 19 generates electric power during operation of the internal combustion engine 17, the hybrid controller 23 illustrated in FIG. 2 modulates the power generation torque which is torque required for allowing the generator motor 19 to generate electric power (that is, increases the power generation torque with the lapse of time). With such control, since the rotation speed n and the torque T of the internal combustion engine 17 during power generation gradually increase with the lapse of time, an abrupt increase in the rotation speed n of the internal combustion engine 17 is suppressed and the sense of incongruity decreases. Next, a control example of the generator motor 19 and the internal combustion engine 17 during power generation will be described in more detail.

<Control Example when Generator Motor 19 Generates Electric Power>

FIG. 5 is a diagram illustrating an example of a change with the lapse of time t in the power generation torque Tg when the generator motor 19 generates electric power according to the embodiment. FIGS. 6 and 7 are diagrams for describing the operating state of the internal combustion engine 17 when the generator motor 19 is driven by the internal combustion engine 17 to generate electric power. FIG. 6 illustrates the state at time t=t1 and FIG. 7 illustrates the state at time t=t2.

In the embodiment, when the generator motor 19 is generating electric power, the power generation torque has a negative value. When the generator motor 19 operates as a motor to assist the internal combustion engine 17, the driving torque which is the torque generated by the generator motor 19 has a positive value. In the embodiment, the power generation torque Tg and the power generation torque command value Tgc decrease with the lapse of time t. This means the absolute values of the power generation torque Tg and the power generation torque command value Tgc increase with the lapse of time t as illustrated in FIG. 5. In the embodiment, although the absolute values of the power generation torque Tg and the power generation torque command value Tgc change according to a linear function of time t, the change in the absolute values of the power generation torque Tg and the power generation torque command value Tgc is not limited to this. For example, the absolute values of the power generation torque Tg and the power generation torque command value Tgc may change according to a quadratic function, a cubic function, an exponential function, or the other function of time t.

When the generator motor 19 is not generating electric power, the internal combustion engine 17 operates at the matching point MP0 as illustrated in FIG. 6. The matching point MP0 is the intersection of the matching line ML, the output command line ILe, and the pump absorption torque line PL0. At the matching point MP0, the rotation speed of the internal combustion engine 17 is nm0.

When the generator motor 19 generates electric power due to deficiency in the amount of charge stored in the storage battery device 22, the hybrid controller 23 illustrated in FIG. 2 calculates a target power generation output Pgt which is horsepower (that is, an output) required for the generator motor 19 to generate electric power. Moreover, the hybrid controller 23 calculates a target power generation torque Tgt which is the power generation torque required for the generator motor 19 to generate electric power from the obtained target power generation output Pgt. The target power generation output Pgt and the target power generation torque Tgt are negative values.

The hybrid controller 23 increases the absolute values |Pgt| and |Tgt| of the obtained target power generation output Pgt and the obtained target power generation torque Tgt with the lapse of time t and outputs the absolute values to the generator motor control device 19I illustrated in FIG. 2. The power generation output Pg and the power generation torque Tg output by the hybrid controller 23 will be appropriately referred to as power generation output Pgot and power generation torque Tgot.

The pump controller 33 illustrated in FIG. 2 acquires the power generation output Pgot from the hybrid controller 23 via the in-vehicle LAN 35. The power generation output that the pump controller 33 acquires may be the absolute value |Pgt| of the target power generation output Pgt. The pump controller 33 adds the absolute value |Pgot| of the power generation output Pgot to the output indicated by the output command line ILe which is an output command value output to the internal combustion engine 17 when the generator motor 19 is not generating electric power to calculate the output command value during power generation. In the example illustrated in FIG. 6, the output command value during power generation is an output command line ILg1.

The torque Te is a value obtained by adding the absolute value |Tgot| of the power generation torque Tgot to the torque generated by the internal combustion engine 17 when the generator motor 19 is not generating electric power. The torque Te is the same as the torque calculated from the intersection of the matching line ML and the output indicated by the output command line ILg1 which is the output command value of the internal combustion engine 17 during power generation.

When the generator motor 19 starts power generation and a period of time t=t1 elapses, the internal combustion engine 17 operates at the matching point MP1 as illustrated in FIG. 6. The matching point MP1 is the intersection of the matching line ML and the output command line ILg1. At the matching point MP1, the rotation speed of the internal combustion engine 17 is nm1.

When the generator motor 19 generates electric power, the output of the internal combustion engine 17 absorbed by the hydraulic pump 18 decreases by an amount corresponding to the horsepower absorbed by the generator motor 19 (that is, the absolute value |Pgot| of the power generation output Pgot). The pump absorption torque line PL0 moves to the pump absorption torque line PL1 indicated by a dot line. The pump absorption torque line PL1 passes through the intersection of the output command line ILe when the generator motor 19 is not generating electric power and the rotation speed nm1 of the internal combustion engine 17 at the matching point MP1. The torque absorbed by the hydraulic pump 18 illustrated in FIG. 2 is Tp. During power generation, a value obtained by adding the torque Tp absorbed by the hydraulic pump 18 and the absolute value |Tgot| of the power generation torque Tgot is the torque Te of the internal combustion engine 17.

When the period t elapses from t0 to t2, the power generation output Pgot and the power generation torque Tgot decrease. That is, the absolute values |Pgot| and |Tgot| of the power generation output Pgot and the power generation torque Tgot increase. At time t=t2, the output command value of the internal combustion engine 17 during power generation is an output command line ILg2. The absolute values |Pgot| and |Tgot| of the power generation output Pgot and the power generation torque Tgot at time t=t2 are larger than the values at time t=t1. Thus, the output command line ILg2 which is the output command value at time t=t2 is larger than the output command line ILg1 which is the output command value at time t=t1.

At time t=t2, the internal combustion engine 17 operates at the matching point MP2 as illustrated in FIG. 7. The matching point MP2 is the intersection of the matching line ML and the output command line ILg2. At the matching point MP2, the rotation speed of the internal combustion engine 17 is nm2. At time t=t2, the pump absorption torque line PL0 during non-power generation moves to the pump absorption torque line PL2 indicated by the solid line. The pump absorption torque line PL2 passes through the intersection of the output command line ILe when the generator motor 19 is not generating electric power and the rotation speed nm2 of the internal combustion engine 17 at the matching point MP2.

When the generator motor 19 generates electric power, the pump controller 33 illustrated in FIG. 2 decreases the pump absorption torque from torque Te to torque Tp so that the generator motor 19 can generate electric power. A difference between the torque Te and the torque Tp is the torque that the generator motor 19 absorbs during power generation. The pump controller 33 illustrated in FIG. 2 changes the command value of the pump absorption torque line PL from the pump absorption torque line PL0 to the pump absorption torque line PL2 so that the torque absorbed by the hydraulic pump 18 changes from Te to Tp and outputs the command value to the hydraulic pump 18. That is, the pump controller 33 decreases the absorption torque which is the torque absorbed by the hydraulic pump 18. As a result, as illustrated in FIGS. 6 and 7, the pump absorption torque line changes in the order of PL0, PL1, and PL2.

Since a response delay occurs in the operation of the hydraulic pump 18, after a command value for decreasing the pump absorption torque is output, the actual pump absorption torque decreases gradually. In contrast, the operation of the generator motor 19 responds substantially without any delay. Due to this, if the target power generation torque Tgt is output from the hybrid controller 23 to the generator motor control device 19I, an increase in the torque absorbed by the generator motor 19 (that is, the torque with which the internal combustion engine 17 drives the generator motor 19) is faster than a decrease in the pump absorption torque. As a result, the rotation speed n of the internal combustion engine 17 decreases abruptly due to excessive load acting on the internal combustion engine 17. After that, when the pump absorption torque decreases up to the target value, a phenomenon that the rotation speed n of the internal combustion engine 17 increases again may occur.

In the embodiment, the absolute values |Pgot| and |Tgot| of the power generation output Pgot and the power generation torque Tgot increase with the lapse of time t. Due to this, since the output command value of the internal combustion engine 17 also increases with the lapse of time t, the torque Te of the internal combustion engine 17 also increases with the lapse of time. When the output command value and the torque Te of the internal combustion engine 17 increase with the lapse of time t, the matching point MP moves from the matching point MP0 when the generator motor 19 does not generate electric power to the matching point MP2 along the matching line ML as indicated by an arrow trg in FIG. 7. Due to this, the torque Te of the internal combustion engine 17 is suppressed from exceeding the maximum torque line TL in a period from the start of power generation of the generator motor 19 to the time at which the generator motor 19 is driven by the internal combustion engine 17 to operate with the target power generation output Pgt and the target power generation torque Tgt. As a result, a phenomenon that the rotation speed n of the internal combustion engine 17 increases again after an abrupt decrease is suppressed. That is, in the embodiment, a decrease and an increase in the rotation speed n of the internal combustion engine 17 is suppressed by increasing the absolute values |Pgot| and |Tgot| of the power generation output Pgot and the power generation torque Tgot with the lapse of time t to secure a period until the pump absorption torque decreases up to the target value.

A period from the start of power generation of the generator motor 19 to the time at which the generator motor 19 to the time at which the generator motor 19 is driven by the internal combustion engine 17 to operate with the target power generation output Pgt and the target power generation torque Tgt changes according to an increase amount (that is, a power generation torque increase rate) per unit time in the absolute value |Tg| of the power generation torque Tg. If the power generation torque increase rate is small, the increase rate of the absolute values |Pgot| and |Tgot| of the power generation output Pgot and the power generation torque Tgot decreases relatively. If the power generation torque increase rate is large, the increase rate of the absolute values |Pgot| and |Tgot| of the power generation output Pgot and the power generation torque Tgot increases relatively.

In the embodiment, the unit of the power generation torque increase rate is N·m/sec. The power generation torque increase rate may be a predetermined value and may be changed according to an operation condition of the excavator 1 or the state of the excavator 1.

In the embodiment, the hybrid controller 23 increases the absolute value |Tgot| of the power generation torque Tgot from an absolute value of a first value up to an absolute value of a second value with the lapse of time t. The first value is 0 [N/m], for example, and the second value is a lowest power generation torque, for example. Since the generator motor 19 cannot generate electric power efficiently with power generation torque smaller than the lowest power generation torque, the amount of electric power stored in the storage battery device 22 rarely increases even if the generator motor 19 generates electric power. In the embodiment, the hybrid controller 23 allows the generator motor 19 to start power generation when the absolute value |Tgt| of the target power generation torque Tgt is equal to or larger than the lowest power generation torque. An output determined by the lowest power generation torque and the rotation speed n of the internal combustion engine 17 at that time is referred to as a lowest power generation output.

In the embodiment, using the absolute value of the second value as a lowest power generation torque, the hybrid controller 23 increases the absolute value |Tgot| of the power generation torque Tgot from the first value to the second value with the lapse of time t. With this process, since the absolute value |Tgot| of the power generation torque Tgot reaches the absolute value |Tgt| of the target power generation torque Tgt without a delay when it reaches the second value, a response delay in power generation is suppressed. Moreover, since the absolute value |Tgot| of the power generation torque Tgot increases from the first value to the second value with the lapse of time t, a sense of incongruity due to an abrupt increase in the rotation speed n of the internal combustion engine 17 at the start of power generation is suppressed.

<Example of Changing Power Generation Torque Increase Rate>

In the embodiment, the power generation torque increase rate may be changed based on a swing horsepower required for allowing the upper swing structure 5 to swing. The swing horsepower is a horsepower required for the swing motor 24 illustrated in FIG. 2 to allow the upper swing structure 5 to swing.

Whether the generator motor 19 generates electric power or not is determined based on an amount of electric power stored in the storage battery device 22 (in the embodiment, a voltage across terminals of the storage battery device 22). The power generation torque increase rate may be changed based on the voltage across terminals of the storage battery device 22 (for example, the power generation torque increase rate may be increased as the voltage across terminals decreases). Since the swing horsepower increases when the upper swing structure 5 accelerates, the electric power generated by the generator motor 19 to drive the swing motor 24 also increases. Due to this, even when the power generation torque increase rate is changed based on the voltage across terminals of the storage battery device 22, since it is not possible to compensate for the increase in the swing horsepower, the amount of electric power generated by the generator motor 19 may be insufficient.

In the embodiment, the hybrid controller 23 increases the power generation torque increase rate as the swing horsepower increases. In this case, the hybrid controller 23 may set the power generation torque increase rate to a constant value when the swing horsepower is between 0 and a predetermined magnitude and may increase the power generation torque increase rate as the swing horsepower increases when the swing horsepower has the predetermined magnitude or larger. When the power generation torque increase rate is increased as the swing horsepower increases, the power generation torque increase rate may be increased according to a linear function, a quadratic function, an exponential function, or the other function of the swing horsepower. The hybrid controller 23 may increase a torque increase rate and change the command torque from Te0 to Tep.

When the power generation torque increase rate is increased as the swing horsepower increases, since a response time elapsed until the internal combustion engine 19 generates power generation torque with which the generator motor 19 can generate electric power efficiently decreases, it becomes easy to secure electric power required for the upper swing structure 5 to swing. Although the increase rate of the rotation speed n of the internal combustion engine 17 increases as the power generation torque increase rate increases, an accurate operation of the working unit 3 is not performed during the swing of the upper swing structure 5. Due to this, even when the power generation torque increase rate is increased during the swing of the upper swing structure 5, there is substantially no influence on the operator of the excavator 1. Thus, an increase in the increase rate of the rotation speed n of the internal combustion engine 17 is allowed.

When the generator motor 19 operates as a motor, it is possible to assist the internal combustion engine 17. When the generator motor 19 operates as a motor, the generator motor 19 uses the electric power stored in the storage battery device 22. When the generator motor 19 frequently assists the internal combustion engine 17, the electric power stored in the storage battery device 22 decreases and the voltage across terminals decreases greatly. When the generator motor 19 generates electric power and the power generation torque Tg is increased with the lapse of time t, the amount of electric power may become insufficient and the voltage across terminals of the storage battery device 22 may decrease abnormally.

For example, the assistance of the internal combustion engine 17 includes engine speed assist. The engine speed assist involves operating the operating levers 26R, 26L to increase the rotation speed n from a state in which the rotation speed n of the internal combustion engine 17 is low in a lever neutral state. After the rotation speed n increases with the engine speed assist, although an assist mode changes to a power generation mode, there is a demand to suppress a variation in the rotation speed n of the internal combustion engine 17.

In the embodiment, the hybrid controller 23 illustrated in FIG. 2 can change the power generation torque increase rate based on the amount of electric power stored in the storage battery device 22. For example, the hybrid controller 23 can increase the power generation torque increase rate when the amount of electric power stored in the storage battery device 22 decreases (that is, the voltage across terminals of the storage battery device 22 decreases).

In the embodiment, the hybrid controller 23 changes the power generation torque increase rate based on a target power generation output determined from a voltage deviation which is a deviation between a target voltage across terminals of the storage battery device 22 and the present voltage across terminals. More specifically, the power generation torque increase rate increases as the target power generation output increases (that is, the voltage deviation increases). Since the voltage deviation increases as the amount of electric power stored in the storage battery device 22 decreases, the power generation torque increase rate is increased when the amount of electric power stored in the storage battery device 22 decreases. There is a demand to secure the amount of electric power generated by the generator motor 19 while suppressing a variation in the rotation speed n of the internal combustion engine 17 when the operation of the generator motor 19 transitions from an assist mode to a power generation mode.

When the power generation torque increase rate is changed based on the target power generation output, the hybrid controller 23 may set the power generation torque increase rate to a constant value when the absolute value of the target power generation output is between 0 and a predetermined magnitude and may increase the power generation torque increase rate as the absolute value of the target power generation output increases when the absolute value of the target power generation output is equal to or larger than the predetermined magnitude. Since the target power generation output has a negative value, the absolute value of the target power generation output is used.

With such a process, even when the generator motor 19 frequently assists the internal combustion engine 17, the possibility that the voltage across terminals of the storage battery device 22 decreases abnormally. A situation in which the generator motor 19 frequently assists the internal combustion engine 17 is a state in which the rotation speed n of the internal combustion engine 17 varies. Thus, it is allowed to increase the power generation torque increase rate is increased so that the rotation speed n of the internal combustion engine 17 increases abruptly.

### Embodiment and Comparative Example

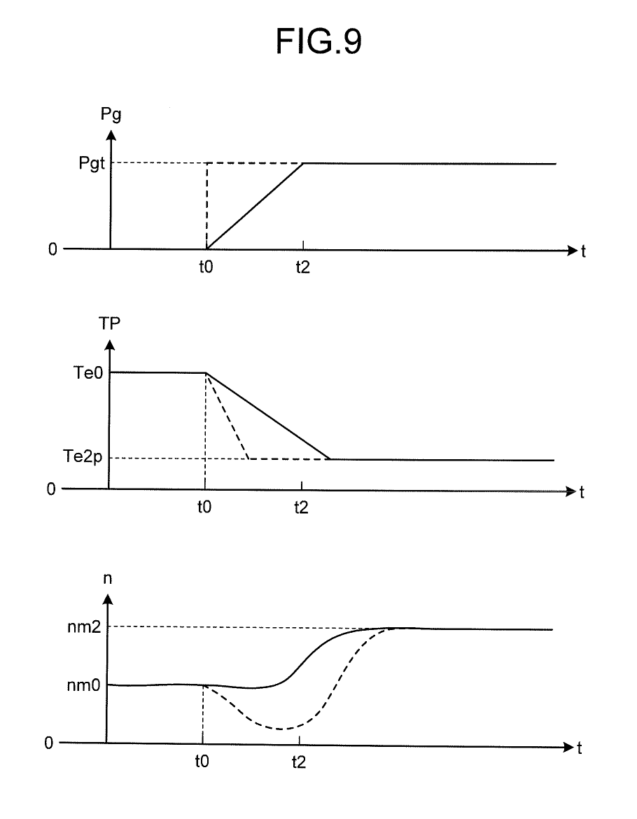

FIG. 8 is a diagram for describing an operating state of the internal combustion engine 17 when the generator motor 19 is driven by the internal combustion engine 17 to generate electric power according to a comparative example. FIG. 9 is a timing chart for describing the operating state of the internal combustion engine when the generator motor is driven by the internal combustion engine to generate electric power according to the comparative example. The vertical axes in FIG. 9 indicate the power generation output Pg, the absorption torque TP of the hydraulic pump 18, and the rotation speed n of the internal combustion engine 17. The horizontal axes in FIG. 9 indicate time t and the power generation by the generator motor 19 starts at time t0. The solid lines in FIG. 9 indicate the embodiment and the broken lines indicate the comparative example. In the comparative example, the output of the internal combustion engine 17 and the load of the hydraulic pump 18 are balanced at the matching point MP0 which is the intersection of the matching line ML, the output command line ILe, and the pump absorption torque line PL0. When the generator motor 19 generates electric power, the hybrid controller 23 outputs the target power generation torque Tgt to the generator motor control device 19I without changing the target power generation torque with the lapse of time.

In comparative example, when the power generation of the generator motor 19 starts at time t0, the power generation output Pg changes from 0 to the target power generation output Pgt as illustrated in FIG. 9. The output command value output to the internal combustion engine 17 is an output command line ILg2 obtained by adding the target power generation output Pgt to the output command line ILe. The pump absorption torque line PL0 that passes through the intersection of the output command line ILe and the matching line ML is changed to the pump absorption torque line PL2. The pump absorption torque line PL2 passes through a coordinate determined by a rotation speed nm2 corresponding to the intersection of the output command line ILg2 and the matching line ML and the torque Te2p on the output command line ILe corresponding to the rotation speed nm2.

At the intersection of the output command line ILe and the matching line ML, the torque of the internal combustion engine 17 is Te0 and the rotation speed is nm0. At the intersection of the output command line ILg2 and the matching line ML, the torque of the internal combustion engine 17 is Te2 and the rotation speed is nm2. At the intersection of the pump absorption torque line PL2 and the output command line ILg2, the torque of the internal combustion engine 17 is Te2p and the rotation speed is nm2.

When the generator motor 19 generates electric power, the pump absorption torque changes from Te0 to Te2p. The pump controller 33 illustrated in FIG. 2 generates a pump absorption torque command value so that the torque absorbed by the hydraulic pump 18 changes from Te0 to Te2p and outputs the command value to the hydraulic pump 18. As a result, since the pump absorption torque line transitions from PL0 to PL2, the pump absorption torque also changes from the torque Te0 corresponding to the pump absorption torque line PL0 to the torque Te2p corresponding to the pump absorption torque line PL2. Since a response delay occurs in the operation of the hydraulic pump 18, the actual pump absorption torque decreases gradually after the changed pump absorption torque command value is output.

The operation of the generator motor 19 responds substantially without a delay when a command is issued. Thus, in the comparative example, the generator motor 19 generates electric power corresponding to the target power generation output Pgt at time t0 as indicated by a broken line in FIG. 9. When the target power generation torque Tgt is issued from the hybrid controller 23 to the generator motor control device 19I, the output command value output to the internal combustion engine 17 changes from the output command line ILe to the output command line ILg2 at time t0. As a result, the torque Te2 at the intersection of the output command line ILg2 and the matching line ML acts on the internal combustion engine 17.

When power generation starts, the torque Te2 obtained by adding the power generation torque Tgt when the rotation speed n of the internal combustion engine 17 reaches the rotation speed nm0 acts on the internal combustion engine 17 operating with the torque Te0 before the power generation of the generator motor 19 starts before the pump absorption torque when the rotation speed n of the internal combustion engine 17 is the rotation speed nm2 reaches Te2p. As a result, since the torque exceeding the maximum torque line TL acts on the internal combustion engine 17, the rotation speed n of the internal combustion engine 17 decreases as indicated by the broken line between time t0 and time t2 in FIG. 9. After that, the rotation speed n of the internal combustion engine 17 increases as the pump absorption torque approaches Te2p. When the rotation speed n of the internal combustion engine 17 reaches the rotation speed nm2, the internal combustion engine 17 operates at the matching point MP2 which is the intersection of the matching line ML and the output command line ILg2.

In the comparative example, when the generator motor 19 generates electric power, the rotation speed n of the internal combustion engine 17 may be increased up to the target rotation speed nm2 with the lapse of time t using the rotation speed nm2 at the intersection of the matching line ML and the output command line ILg as a target rotation speed. However, even when the rotation speed n of the internal combustion engine 17 is increased with the lapse of time t, it is inevitable that the torque Te2 when the rotation speed n of the internal combustion engine 17 reaches the rotation speed n0 acts on the internal combustion engine 17 before the pump absorption torque when the rotation speed n of the internal combustion engine 17 reaches the rotation speed n2 reaches Te2p. As a result, since the torque exceeding the maximum torque line TL acts on the internal combustion engine 17, a phenomenon that the rotation speed n of the internal combustion engine 17 increases after a short period of decrease may occur. In particular, when the matching line ML approaches the maximum torque line TL like the matching line MLb illustrated in FIG. 3, the possibility that the internal combustion engine 17 can generate the torque T larger than the torque T determined by the matching line ML decreases. Due to this, in the comparative example, the closer the matching line ML approaches the maximum torque line TL, the more likely the phenomenon that the rotation speed n of the internal combustion engine 17 decreases during power generation of the generator motor 19 is to occur.

In the embodiment, when the generator motor 19 generates electric power, the power generation torque Pg rather than the rotation speed n of the internal combustion engine 17 increases with the lapse of time t. With such a process, in the embodiment, the output command line IL corresponding to the output command value increases gradually, and the pump absorption torque line decreases gradually from PL0 to PL2 as illustrated in FIG. 9. As a result, in the embodiment, during power generation of the generator motor 19, since the rotation speed n of the internal combustion engine 17 can be increased gradually with the lapse of time t, an abrupt increase in the rotation speed n can be suppressed.

In the embodiment, since the power generation torque Tg is increased with the lapse of time t, the torque Te of the internal combustion engine 17 is suppressed from exceeding the maximum torque line TL until the generator motor 19 is driven with the target power generation torque Tgt by the internal combustion engine 17. As a result, a phenomenon that the rotation speed n of the internal combustion engine 17 decreases abruptly due to application of excessive load to the internal combustion engine 17 is suppressed. In the embodiment, even when the matching line ML approaches the maximum torque line TL to operate the internal combustion engine 17 on the low rotation speed side where satisfactory fuel efficiency is obtained, a phenomenon that the rotation speed n of the internal combustion engine 17 decreases during power generation of the generator motor 19 can be suppressed. In this manner, in the embodiment, it is possible to suppress an increase and a decrease in the rotation speed n of the internal combustion engine 17 during power generation of the generator motor 19.

<Configuration Example of Hybrid Controller 23>

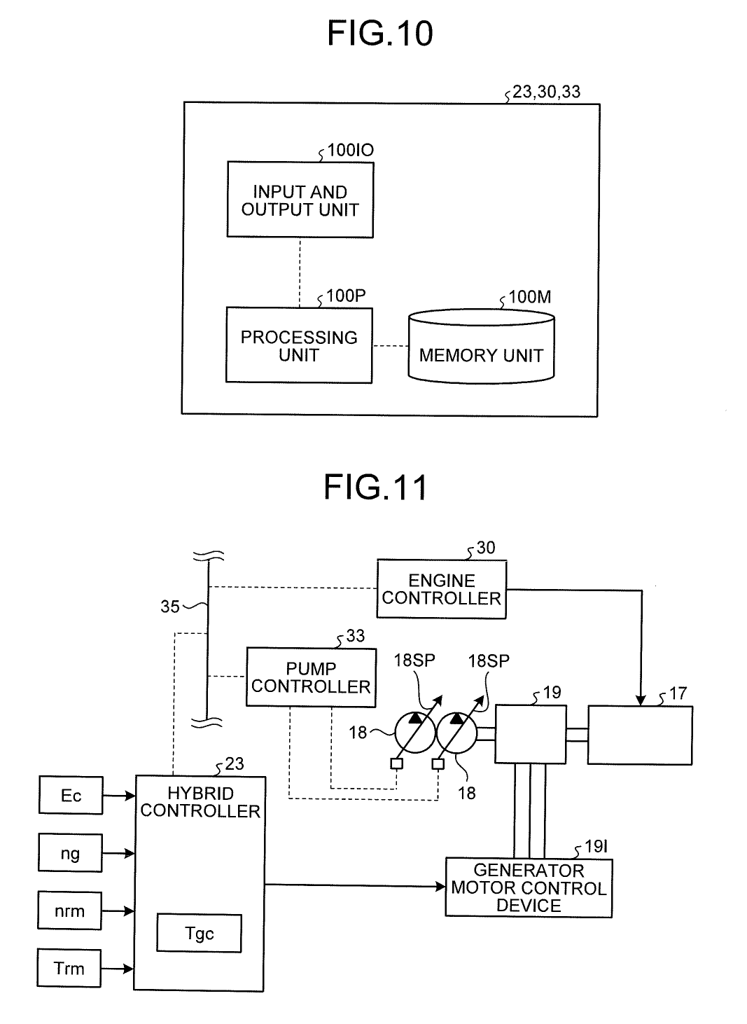

FIG. 10 is a diagram illustrating a configuration example of the hybrid controller 23, the engine controller 30, and the pump controller 33. The hybrid controller 23, the engine controller 30, and the pump controller 33 each include a processing unit 100P, a memory unit 100M, and an input and output unit 10010. The processing unit 100P is a CPU, a microprocessor, a microcomputer, or the like. The processing unit 100P executes the hybrid work machine engine control method according to the embodiment.

When the processing unit 100P is dedicated hardware, one or a combination of various circuits, a programmed processor, and an application specific integrated circuit (ASIC) corresponds to the processing unit 100P.

At least one of various nonvolatile or volatile memories such as a random access memory (RAM) or a read only memory (ROM) and various discs such as a magnetic disk is used as the memory unit 100M. The memory unit 100M stores a computer program for allowing the processing unit 100P to execute engine control according to the embodiment and information used when the processing unit 100P executes the engine control according to the embodiment. The processing unit 100P realizes the engine control according to the embodiment by reading and executing the computer program from the memory unit 100M.

The input and output unit 10010 is an interface circuit for connecting the hybrid controller 23, the engine controller 30, or the pump controller 33 to devices.

<Excavator Control System>

FIG. 11 is a diagram illustrating a control system 1CT of the excavator 1. The voltage across terminals Ec of the storage battery device 22, the rotation speed ng of the generator motor 19, the rotation speed nrm of the swing motor 24, and the torque Trm of the swing motor 24 are input to the hybrid controller 23. The hybrid controller 23 generates a power generation torque command value Tgc which is a command value for the power generation torque Tg when the generator motor 19 generates electric power using these input values.

The power generation torque command value Tgc is transmitted to the generator motor control device 19I to allow the generator motor 19 to generate electric power. The engine controller 30 acquires the power generation torque command value Tgc from the hybrid controller 23 via the in-vehicle LAN 35 and uses the power generation torque command value Tgc in controlling the internal combustion engine 17. The pump controller 33 acquires the power generation torque command value Tgc from the hybrid controller 23 via the in-vehicle LAN 35 and uses the power generation torque command value Tgc in controlling the hydraulic pump 18. The flow rate of the operating oil discharged from the hydraulic pump 18 is controlled when the angle of a swash plate 18SP changes.

<Control Block of Hybrid Controller 23>

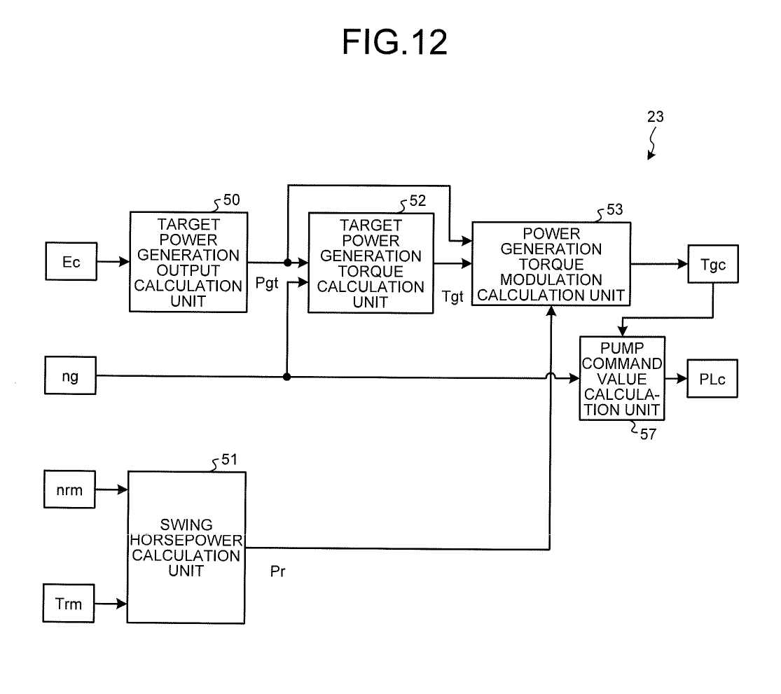

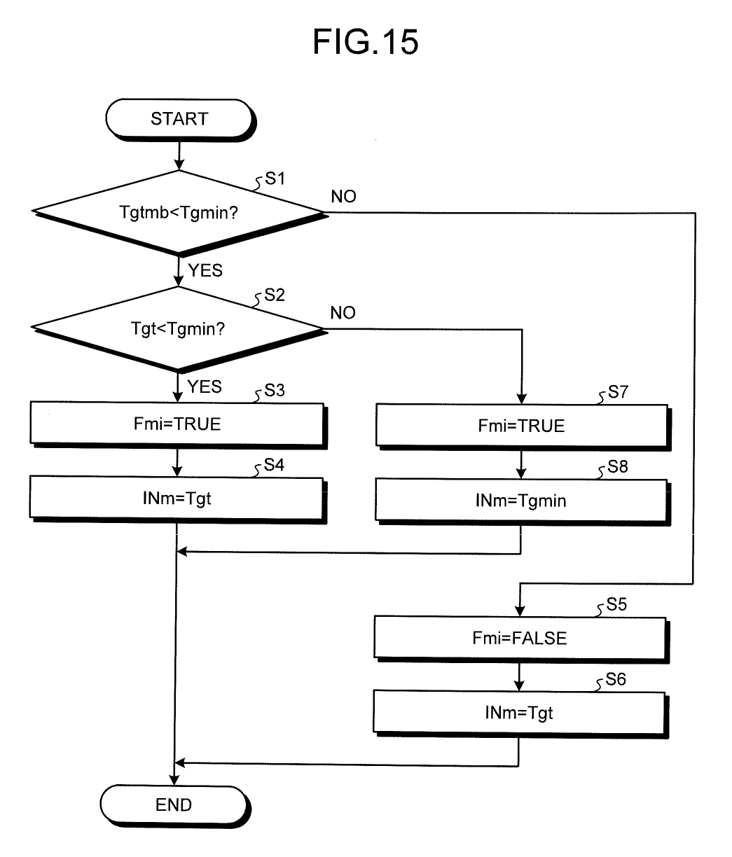

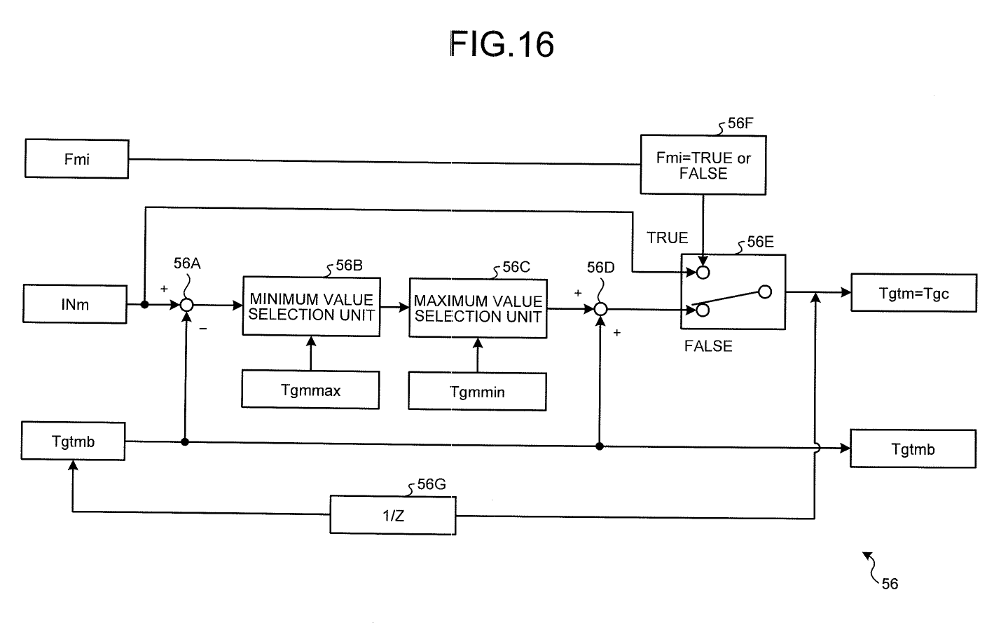

FIGS. 12 to 14 are control block diagrams of the hybrid controller 23 that executes the hybrid work machine engine control method according to the embodiment. FIG. 15 is a flowchart illustrating the process of an input value calculation unit. FIG. 16 is a control block diagram of the hybrid controller 23 that executes the hybrid work machine engine control method according to the embodiment.

As illustrated in FIG. 12, the hybrid controller 23 includes a target power generation output calculation unit 50, a swing horsepower calculation unit 51, a target power generation torque calculation unit 52, a power generation torque modulation calculation unit 53, and a pump command value calculation unit 57. These units execute the hybrid work machine engine control method according to the embodiment. These functions are realized by the processing unit 100P of the hybrid controller 23. The processing unit 100P reads and executes the computer program that executes the hybrid work machine engine control method according to the embodiment from the memory unit 100M to realize the functions of the target power generation output calculation unit 50, the swing horsepower calculation unit 51, the target power generation torque calculation unit 52, and the power generation torque modulation calculation unit 53, for example.

The target power generation output calculation unit 50 calculates the target power generation output Pgt using the voltage across terminals Ec of the storage battery device 22. The target power generation output Pgt is calculated by multiplying a gain G which is a negative value by a voltage deviation ΔEc which is a deviation between the target voltage across terminals Ect of the storage battery device 22 and the present voltage across terminals Ec. In the embodiment, this is because the power generation torque Tg and the power generation output Pg are represented as a negative value as described above. The target power generation output calculation unit 50 outputs the calculated target power generation output Pgt to the target power generation torque calculation unit 52. In the embodiment, the target voltage across terminals Ect is a fixed value and is stored in the memory unit 100M of the hybrid controller 23.

The swing horsepower calculation unit 51 calculates the swing horsepower Pr using the rotation speed nrm of the swing motor 24 and the torque Trm of the swing motor 24 and outputs the swing horsepower Pr to the power generation torque modulation calculation unit 53. The swing horsepower Pr can be calculated by Equation (1). H in Equation (1) is a coefficient. In the embodiment, the coefficient H is a fixed value and is stored in the memory unit 100M of the hybrid controller 23.

Pr=2×π/60×nrm×Trm/1000×H (1)

The target power generation torque calculation unit 52 calculates the target power generation torque Tgt using the target power generation output Pgt and outputs the target power generation torque Tgt to the power generation torque modulation calculation unit 53. The power generation torque modulation calculation unit 53 generates the power generation torque command value Tgc using the target power generation output Pgt, the target power generation torque Tgt, and the swing horsepower Pr and outputs the power generation torque command value Tgc.

The pump command value calculation unit 57 multiplies the torque determined by the power generation torque command value Tgc by the rotation speed of the internal combustion engine 17 to calculate an absorption horsepower of the hydraulic pump 18. In this example, since the generator motor 19 is driven by the internal combustion engine 17, the rotation speed ng of the generator motor 19 is used as the rotation speed of the internal combustion engine 17. The pump command value calculation unit 57 calculates a command value PLc output to the hydraulic pump 18 from the calculated absorption horsepower of the hydraulic pump 18. The command value PLc is a command for setting an inclination angle of the swash plate 18SP of the hydraulic pump 18 to a magnitude required for absorbing the absorption horsepower of the hydraulic pump 18. The pump command value calculation unit 57 can increase and decrease the absorption torque of the hydraulic pump 18 by changing the absorption horsepower of the hydraulic pump 18.

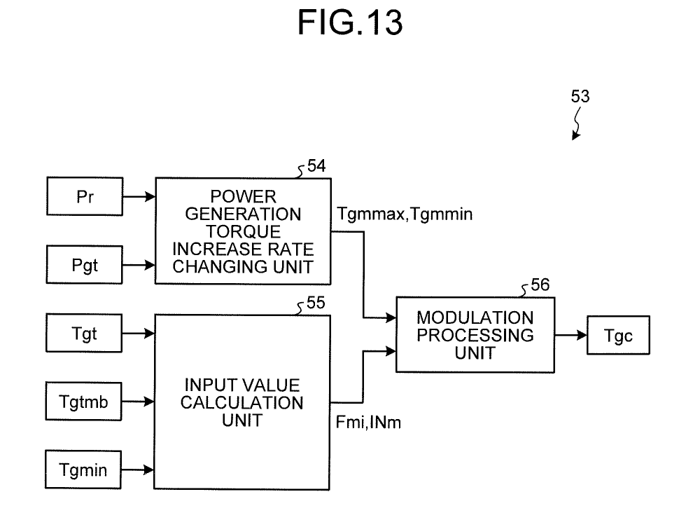

As illustrated in FIG. 13, the power generation torque modulation calculation unit 53 includes a power generation torque increase rate changing unit 54, an input value calculation unit 55, and a modulation processing unit 56. The power generation torque increase rate changing unit 54 calculates a first value Tgmmax that determines the maximum value of the power generation torque increase rate and a second value Tgmmin that determines the minimum value of the power generation torque increase rate from the swing horsepower Pr and the target power generation output Pgt and outputs the first and second values to the modulation processing unit 56.

The input value calculation unit 55 calculates an invalid flag Fmi and a power generation torque input value INm using the target power generation torque Tgt, a previous value Tgtmb, and the lowest power generation torque Tgmin and outputs the invalid flag Fmi and the power generation torque input value INm to the modulation processing unit 56. The modulation processing unit 56 generates the power generation torque command value Tgc using the first value Tgmmax, the second value Tgmmin, the invalid flag Fmi, and the power generation torque input value INm and outputs the power generation torque command value Tgc. The previous value Tgtmb is the power generation torque command value Tgc that the modulation processing unit 56 outputs before one cycle of the control cycle of the hybrid controller 23.

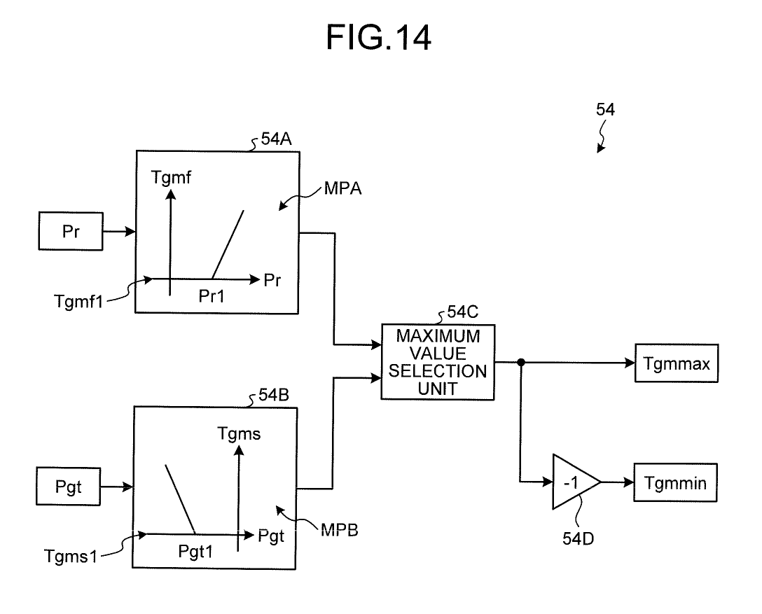

As illustrated in FIG. 14, the power generation torque increase rate changing unit 54 includes a first conversion unit 54A, a second conversion unit 54B, a maximum value selection unit 54C, and an inversion unit 54D. The first conversion unit 54A calculates a first parameter Tgmf for changing the power generation torque increase rate using the swing horsepower Pr and outputs the first parameter Tgmf. The second conversion unit 54B calculates a second parameter Tgms for changing the power generation torque increase rate using the target power generation output Pgt and outputs the second parameter Tgms.

The first conversion unit 54A calculates the first parameter Tgmf using a first conversion table MPA. The first conversion table MPA describes the relation between the swing horsepower Pr and the first parameter Tgmf. According to the first conversion table MPA, the first parameter Tgmf has a constant value Tgmf1 when the swing horsepower Pr is smaller than a predetermined value Pr1 and the first parameter Tgmf increases with an increase in the swing horsepower Pr when the swing horsepower Pr reaches the predetermined value Pr1 or larger.

The second conversion unit 54B calculates the second parameter Tgms using the second conversion table MPB. The second conversion table MPB describes the relation between the target power generation output Pgt and the second parameter Tgms. According to the second conversion table MPB, the second parameter Tgms has a constant value Tgms1 when the absolute value of the target power generation output Pgt is smaller than a predetermined value Pgt1 and the second parameter Tgms increases with an increase in the target power generation output Pgt when the absolute value of the target power generation output Pgt reaches a predetermined value Pft1 or larger.

In the embodiment, the first parameter Tgmf and the second parameter Tgms are torque and the unit is N·m. Since the first parameter Tgmf and the second parameter Tgms are calculated in each control cycle of the hybrid controller 23, the first parameter Tgmf and the second parameter Tgms per one control cycle are the power generation torque increase rate.

The maximum value selection unit 54C selects the larger one of the first parameter Tgmf and the second parameter Tgms and outputs the selected one. The value output by the maximum value selection unit 54C is the first value Tgmmax. The value output by the maximum value selection unit 54C is passed to the inversion unit 54D. The inversion unit 54D assigns a negative sign to the value output by the maximum value selection unit 54C and outputs the value. The value output by the inversion unit 54D is the second value Tgmmin. The absolute value of the first value Tgmmax and the absolute value of the second value Tgmmin are the same.

The process of the input value calculation unit 55 will be described using FIG. 15. In step S1, the input value calculation unit 55 compares the previous value Tgtmb and the lowest power generation torque Tgmin. When the previous value Tgtmb is smaller than the lowest power generation torque Tgmin (step S1: Yes), the input value calculation unit 55 compares the target power generation torque Tgt and the lowest power generation torque Tgmin in step S2.

When the target power generation torque Tgt is smaller than the lowest power generation torque Tgmin (step S2: Yes), the input value calculation unit 55 sets the invalid flag Fmi to TRUE in step S3 and sets the power generation torque input value INm to the target power generation torque Tgt in step S4.

When the previous value Tgtmb is equal to or larger than the lowest power generation torque Tgmin (step S1: No), the input value calculation unit 55 sets the invalid flag Fmi to FALSE in step S5 and sets the power generation torque input value INm to the target power generation torque Tgt in step S6.

When the target power generation torque Tgt is equal to or larger than the lowest power generation torque Tgmin (step S2: No), the input value calculation unit 55 sets the invalid flag Fmi to TRUE in step S7 and sets the power generation torque input value INm to the lowest power generation torque Tgmin in step S8.

With such a process, the input value calculation unit 55 can increase the power generation torque Tg with the lapse of time t when the power generation torque Tg is between 0 and the lowest power generation torque Tgmin. Moreover, the input value calculation unit 55 can set the power generation torque Tg to the target power generation torque Tgt when the power generation torque Tg is equal to or larger than the lowest power generation torque Tgmin.

As illustrated in FIG. 16, the modulation processing unit 56 includes a first adder-subtractor 56A, a minimum value selection unit 56B, a maximum value selection unit 56C, a second adder-subtractor 56D, a selection unit 56E, an invalid flag output unit 56F, and a previous value memory unit 56G. The first adder-subtractor 56A subtracts the previous value Tgtmb from the power generation torque input value INm output from the input value calculation unit 55 and outputs the subtraction value to the minimum value selection unit 56B.

The minimum value selection unit 56B selects a smaller one of the value output from the first adder-subtractor 56A and the first value Tgmmax calculated by the power generation torque increase rate changing unit 54 and outputs the selected one to the maximum value selection unit 56C. The maximum value selection unit 56C selects a larger one of the value output from the minimum value selection unit 56B and the second value Tgmmin calculated by the power generation torque increase rate changing unit 54 and outputs the selected one to the second adder-subtractor 56D.

The second adder-subtractor 56D adds the value output from the maximum value selection unit 56C and the previous value Tgtmb and outputs the addition value to the selection unit 56E. The selection unit 56E selects and outputs an input according to the value of the invalid flag Fmi output from the invalid flag output unit 56F to the selection unit 56E. When the invalid flag Fmi is FALSE, the hybrid controller 23 increases the power generation torque Tg with the lapse of time. Thus, the selection unit 56E outputs the result calculated by the second adder-subtractor 56D as a present value Tgtm. The present value Tgtm is the power generation torque command value Tgc.

When the invalid flag Fmi is TRUE, the hybrid controller 23 outputs the power generation torque input value INm as it is without increasing the power generation torque Tg with the lapse of time. Thus, the selection unit 56E outputs the power generation torque input value INm input to the modulation processing unit 56 as the present value Tgtm (that is, the power generation torque command value Tgc). The previous value memory unit 56G means that the previous value Tgtmb of the modulation processing unit 56 is stored in the memory unit 100M of the hybrid controller 23.

The power generation torque input value INm is processed by the first adder-subtractor 56A, the minimum value selection unit 56B, the maximum value selection unit 56C, and the second adder-subtractor 56D and thus the output of the selection unit 56E is modulated. As a result, the power generation torque command value Tgc increases with the lapse of time t. As a result, an abrupt increase in the rotation speed n of the internal combustion engine 17 when the generator motor 19 generates electric power is suppressed.

In the embodiment, the hybrid controller 23 increases the power generation torque command value Tgc with the lapse of time t using the previous value of the power generation torque command value Tgc output by the modulation processing unit 56 and the first and second values Tgmmax and Tgmmin for determining the power generation torque increase rate. A method of increasing the power generation torque command value Tgc with the lapse of time t is not limited to the method used in the embodiment. For example, the modulation processing unit 56 may change the power generation torque command value Tgc output to the power generation torque input value INm according to a primary delay. In this case, the relation between the power generation torque command value Tgc and the power generation torque input value INm is represented by Equation (2), for example. Δtc is a control cycle of the hybrid controller 23 and τ is a relaxation time.

Tgc=INm×Δtc/(Δtc+τ)+Tgtmb×τ/(Δtc+τ) (2)

<Engine Control Method According to Embodiment>

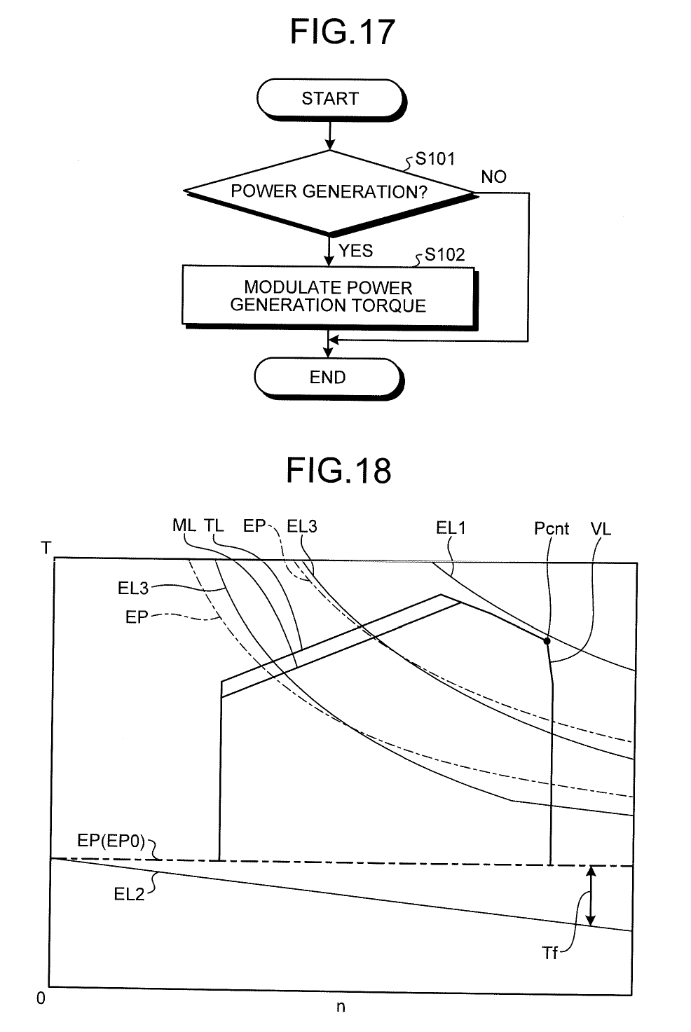

FIG. 17 is a flowchart illustrating an example of a hybrid work machine engine control method according to the embodiment. In step S101, the hybrid controller 23 illustrated in FIG. 2 determines whether the generator motor 19 generates electric power or not based on the amount of electric power stored in the storage battery device 22. For example, the hybrid controller 23 determines that the generator motor 19 generates electric power when a voltage deviation which is a deviation between the target voltage across terminals of the storage battery device 22 and the present voltage across terminals is equal to or smaller than a threshold.

When the generator motor 19 generates electric power (step S101: Yes), the hybrid controller 23 modulates the power generation torque Tg and outputs the modulated power generation torque (step S102). That is, the hybrid controller 23 increases the power generation torque Tg with the lapse of time, outputs the increased power generation torque, and decreases the absorption torque absorbed by the hydraulic pump 18. As a result, since the torque T of the internal combustion engine 17 increases with the lapse of time t, an abrupt increase in the rotation speed n of the internal combustion engine 17 when the generator motor 19 generates electric power is suppressed.

When the generator motor 19 does not generate electric power (step S101: No), the hybrid controller 23 outputs the power generation torque Tg without modulating the same.

<Modified Example of Output Command Line>

FIG. 18 is a diagram for describing a modified example of the output command line according to the embodiment. As described above, although the output command line IL illustrated in FIGS. 4, 6, and 7 is an equivalent horsepower line, an output command line according to a modified example is an equivalent throttle line. The torque diagram illustrated in FIG. 18 illustrates equivalent throttle lines EL1, EL2, and EL3, equivalent horsepower lines EP0 and EP, a limit line VL, a maximum torque line TL of the internal combustion engine 17, and a matching line ML.

The equivalent throttle lines EL1, EL2, and EL3 illustrate the relation between the torque T and the rotation speed n when the setting value (a throttle opening) of a fuel adjustment dial (that is, the throttle dial 28 illustrated in FIG. 2) is the same. The setting value of the throttle dial 28 is a command value for determining the amount of fuel that the common rail control unit 32 injects to the internal combustion engine 17.

The equivalent throttle line EL1 corresponds to a case where the setting value of the throttle dial 28 is 100% (that is, the amount of fuel injected to the internal combustion engine 17 is the largest). The equivalent throttle line EL2 corresponds to a case where the setting value of the throttle dial 28 is 0%. The equivalent throttle line EL3 is a plurality of lines corresponding to large setting values of the throttle dial 28 in that order. The equivalent throttle line EL3 has a value between the maximum value and the minimum value of the fuel injection amount.

The first equivalent throttle line EL1 illustrates the relation between the torque T and the rotation speed n corresponding to a case where the amount of fuel injected to the internal combustion engine 17 is the largest. In the following description, according to the first equivalent throttle line EL1, the output at the rotation speed corresponding to the rated output of the internal combustion engine 17 is set to be equal to or larger than the rated output.

The second equivalent throttle line EL2 illustrates the relation between the torque T and the rotation speed n corresponding to a case where the amount of fuel injected to the internal combustion engine 17 is 0. The equivalent throttle line EL2 is determined so that the torque T of the internal combustion engine 17 decreases as the rotation speed n of the internal combustion engine 17 increases from the point at which the torque T of the internal combustion engine 17 is 0 and the rotation speed n is 0. The decrease rate of the torque T is determined based on frictional torque Tf generated by the internal friction of the internal combustion engine 17.

A plurality of third equivalent throttle lines EL3 is present between the first equivalent throttle line EL1 and the second equivalent throttle line EL2. The third equivalent throttle line EL3 is obtained by interpolating the values of the first equivalent throttle line EL1 and the second equivalent throttle line EL2.

The first equivalent throttle line EL1, the second equivalent throttle line EL2, and the third equivalent throttle line EL3 indicate the targets of the rotation speed n and the torque T of the internal combustion engine 17. In particular, among these equivalent throttle lines, the internal combustion engine 17 is controlled so as to operate with the rotation speed n and the torque T obtained from the third equivalent throttle line EL3. The equivalent horsepower line EP determines the relation between the torque T and the rotation speed n so that the output of the internal combustion engine 17 becomes constant. A point at which the third throttle line EL3 crosses an arbitrary equivalent horsepower line EP may be determined so that the lines cross each other on the matching line ML, for example.

The control devices (for example, the engine controller 30 and the pump controller 33 illustrated in FIG. 2) control the operating state of the internal combustion engine 17 similarly to the embodiment using the third equivalent throttle line EL3.

In the embodiment, although the excavator 1 having the internal combustion engine 17 is illustrated as an example of a work machine, the work machine to which the embodiment can be applied is not limited to this. For example, the work machine may be a wheel loader, a bulldozer, a dump truck, or the like. The type of engine on which the work machine is mounted is not particularly limited.

While the embodiment has been described, the embodiment is not limited to the above-described content. Moreover, the above-described constituent elements include those that can be easily conceived by those skilled in the art, those that are substantially the same as the constituent elements, and those in the range of so-called equivalents. Further, the above-described constituent elements can be appropriately combined with each other. Furthermore, various omissions, substitutions, or changes in the constituent elements can be made without departing from the spirit of the embodiment.

### REFERENCE SIGNS LIST

1 EXCAVATOR
2 VEHICLE BODY
3 WORKING UNIT
5 UPPER SWING STRUCTURE
17 INTERNAL COMBUSTION ENGINE
18 HYDRAULIC PUMP
19 GENERATOR MOTOR
19I GENERATOR MOTOR CONTROL DEVICE
22 STORAGE BATTERY DEVICE
23 HYBRID CONTROLLER
24 SWING MOTOR (MOTOR)
24I SWING MOTOR CONTROL DEVICE
30 ENGINE CONTROLLER
36 ENGINE
50 TARGET POWER GENERATION OUTPUT CALCULATION UNIT
51 SWING HORSEPOWER CALCULATION UNIT
52 TARGET POWER GENERATION TORQUE CALCULATION UNIT
53 POWER GENERATION TORQUE MODULATION CALCULATION UNIT
54 POWER GENERATION TORQUE INCREASE RATE CHANGING UNIT
54A FIRST CONVERSION UNIT
54B SECOND CONVERSION UNIT
54C MAXIMUM VALUE SELECTION UNIT
54D INVERSION UNIT
55 INPUT VALUE CALCULATION UNIT
56 MODULATION PROCESSING UNIT
56A FIRST ADDER-SUBTRACTOR
56B MINIMUM VALUE SELECTION UNIT
56C MAXIMUM VALUE SELECTION UNIT
56D SECOND ADDER-SUBTRACTOR
56E SELECTION UNIT
56G PREVIOUS VALUE MEMORY UNIT
56F INVALID FLAG OUTPUT UNIT
57 PUMP COMMAND VALUE CALCULATION UNIT

1. A hybrid work machine engine control device which is mounted on a hybrid work machine having a working unit that operates with operating oil supplied from a hydraulic pump and which controls an internal combustion engine that drives a generator motor and the hydraulic pump with generated power, comprising:
a processing unit that increases torque required for the generator motor to generate electric power with a lapse of time and decreases absorption torque that the hydraulic pump absorbs when the generator motor generates electric power during operation of the internal combustion engine.

2. The hybrid work machine engine control device according to claim 1, wherein
the processing unit changes a rate at which the torque required for the generator motor to generate electric power is increased with the lapse of time based on an amount of electric power stored in a storage battery device that stores the electric power generated by the generator motor.

3. The hybrid work machine engine control device according to claim 2, wherein
the processing unit increases the rate as the amount of electric power decreases.

4. The hybrid work machine engine control device according to claim 1, wherein
it is determined whether the generator motor generates electric power based on an amount of electric power stored in a storage battery device that stores the electric power generated by the generator motor.

5. The hybrid work machine engine control device according to claim 1, wherein
the hybrid work machine includes a swing structure having the working unit, and
the processing unit changes a rate at which the torque required for the generator motor to generate electric power is increased with the lapse of time based on swing horsepower required for the swing structure to swing.

6. The hybrid work machine engine control device according to claim 5, wherein
the processing unit increases the rate as the swing horsepower increases.

7. A hybrid work machine comprising:
the hybrid work machine engine control device according to claim 1;
the internal combustion engine;
a hydraulic pump driven by the internal combustion engine;
the generator motor driven by the internal combustion engine; and
a storage battery device that stores electric power generated by the generator motor.

8. An engine control method for controlling a hybrid work machine, the engine control method controlling an internal combustion engine which is mounted on the hybrid work machine having a working unit operated by a hydraulic pump and which drives a generator motor and the hydraulic pump with generated power, the engine control method comprising:
determining whether the generator motor generates electric power or not during operation of the internal combustion engine; and
increasing torque required for the generator motor to generate electric power with a lapse of time and decreasing absorption torque that the hydraulic pump absorbs when the generator motor generates electric power during operation of the internal combustion engine.
